(19) United States
(12) Patent Application Publication
(10) Pub. No.: US 2026/0119149 A1
(43) Pub. Date: Apr. 30, 2026

(54) SYSTEM AND METHOD OF ARTIFICIAL INTELLIGENCE PRODUCTIVITY TOOL ORCHESTRATING PERFORMANCE OF CURRENTLY SUPPORTED USER-REQUESTED FIRMWARE CAPABILITIES FOR HARDWARE

(71) Applicant: Dell Products LP, Round Rock, TX (US)

(72) Inventors: Srikanth Kondapi, Austin, TX (US); Daniel L. Hamlin, Round Rock, TX (US); Balasingh Ponraj Samuel, Round Rock, TX (US)

(73) Assignee: Dell Products LP, Round Rock, TX (US)

(21) Appl. No.: 18/929,430

(22) Filed: Oct. 28, 2024

(51) Int. Cl. G06F 8/65; G06N 5/01

(52) U.S. Cl. CPC G06F 8/65; G06N 5/01

(57) ABSTRACT

A system and method for operating an on the box (OTB) artificial intelligence (AI) productivity tool comprising an embedded controller executing code instructions of a platform level capability gathering module to receive a notice of functional adjustment for a hardware component communicating with the embedded controller using one of several available communication protocols and the embedded controller to transmit an updated firmware capability to the OTB AI productivity tool pursuant to the notice of functional adjustment. A hardware processor generates a vectorized capability intent value from the updated firmware capability and a vectorized query input intent value for a received user query input, determines semantic correlation between the vectorized query input intent value for the user query input and the vectorized firmware capability intent value to indicate that the user query input requests performance of the updated firmware capability, and instructs the hardware component to perform the updated firmware capability.

### FIELD OF THE DISCLOSURE

The present disclosure generally relates to an on the box (OTB) artificial intelligence (AI) productivity tool that employs machine learning models stored at an information handling system for optimizing user productivity and information handling system performance with capability responses to user query inputs. The present disclosure more specifically relates to a platform level capabilities gathering module updating a pre-registered runtime firmware capability to an artificial intelligence (AI) productivity tool enableable platform service tool which publishes the runtime firmware capability for a hardware component for access by the OTB AI productivity tool operating at the operating system (OS) level.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more artificial intelligence (AI) productivity tool enableable software applications, chat bots, or the like. Further, the information handling system may include an on the box (OTB) artificial intelligence (AI) productivity tool employing machine learning models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system executing machine readable code instructions for an on the box (OTB) artificial intelligence (AI) productivity tool for discovery and accessibility of updated runtime firmware capabilities for hardware components at a platform level from an AI productivity tool-enableable platform service tool according to an embodiment of the present disclosure;

FIG. 2 is a block diagram illustrating a platform level of an information handling system including an embedded controller executing machine readable code instructions for a platform-level AI productivity tool-enableable platform service tool to automatically update runtime firmware capabilities accessible by an OTB AI productivity tool at an operating system (OS) level according to an embodiment of the present disclosure;

FIG. 3 is a block diagram illustrating a hardware processor executing machine readable code instructions for a platform-level AI productivity tool-enableable platform service tool to automatically update runtime firmware capabilities accessible by an OTB AI productivity tool at an OS level for responding to received user query inputs according to an embodiment of the present disclosure; and

FIG. 4 is a flow diagram illustrating a method of a hardware processor or embedded controller executing machine readable code instructions to automatically update runtime firmware capabilities accessible by an OTB AI productivity tool at an OS level for responding to received user query inputs according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

### INTRODUCTION

Artificial intelligence (AI) is a developing technology that is used to increase efficiency of computing systems and interactions with humans. An example of AI technologies includes, but is not limited to, chat-enabled environments (voice, text, etc.). These chat-enabled environments are described in embodiments herein as an on the box (OTB) AI productivity tool that receives this voice or text input from a user and implements a number of actions or utilizes services of various software applications based on the natural language of the input. In some information handling systems, the OTB AI productivity tool may interface with various AI productivity tool-enablable software applications being executed or executable on the information handling system at an operating system (OS) level. These AI productivity tool-enablable software applications may integrate with the OTB AI productivity tool to allow user queries to trigger certain responsive capability actions declared, supported, and managed by these AI productivity tool-enablable software applications. In embodiments herein, the OTB AI productivity tool executes at the operating system level and may work in tandem with an agent, referred to herein as an AI productivity tool enableable platform service tool, to allow user queries at the OS level OTB AI productivity tool to trigger certain firmware or hardware capability actions at the information handling system platform level declared and supported by runtime firmware capabilities for various hardware components of the information handling system operating at the platform level below the OS of the information handling system.

A hardware processor executing code instructions of the OTB AI productivity tool in embodiments herein may receive user queries via an input/output device such as a keyboard, microphone, or video camera, described herein as user query inputs. The OTB AI productivity tool may match received user query inputs to known available capabilities published for the OTB AI productivity tool via an available capabilities database. The natural language capabilities database and corresponding entries in a capability intent values database may include available application capabilities of AI productivity tool enableable software applications at the OS level as well as runtime firmware capabilities for one or more hardware components executable at the platform level through execution by an embedded controller. The hardware processor executing code instructions of the OTB AI productivity tool may then direct execution of these application capabilities or runtime firmware capabilities for hardware at the platform level based in similarity matching with a user query input received at the OTB AI productivity tool at the OS level. Execution of runtime firmware capabilities for hardware at the platform level may be orchestrated through the AI productivity tool-enableable platform service tool executing at the embedded controller.

Prior to such a process and prior to a user providing such a user query input into an OTB AI productivity tool at the OS level, the embedded controller executing the AI productivity tool-enableable platform service tool may register with the OTB AI productivity tool a list of runtime firmware capabilities achievable by the AI productivity tool-enableable platform service tool as well as one or more versions of firmware for hardware components at the platform level. Such a registration of runtime firmware capabilities at an OTB AI productivity tool, especially those that involve adjusting functionality of hardware components at the information handling system, may not take into account current configurations and policies of those hardware components or current versions of firmware or the AI productivity tool enableable platform service tools. Such current configurations and policies or current firmware versions may disallow or make perfunctory such pre-registered runtime firmware capabilities, such as when updates or platform changes are made to firmware or an enterprise distributes policy changes or updates to multiple platform type information handling systems. For example, a runtime firmware capability for optimizing battery performance may be registered with the OTB AI productivity tool, but such the current versions of firmware or configuration of one or more hardware components may not be capable of performing that registered firmware capability, such as when the battery or other hardware component has been removed from or altered within the information handling system or when a version of the firmware or AI productivity tool-enableable platform service tool may have been recently added to eliminate this function. Thus, each time such a hardware component configuration changes or a version of firmware is altered, or even the AI productivity tool-enableable platform service tool for executing platform level firmware capabilities is changed, the actual list of runtime firmware capabilities performable may change. However, this may not be reflected by the list of registered runtime firmware capabilities registered at the OTB AI productivity tool at the OS level instructing execution of such runtime firmware capabilities in response to a user query input.

A hardware processor for an information handling system executing machine readable code instructions for the OTB AI productivity tool in embodiments herein may address these issues by only instructing performance of runtime firmware capabilities at the platform level that are registered in accordance with current versions, configurations, and policies of the firmware or hardware with an updating system via the AI productivity tool enableable platform service tool. The firmware updating service is based on the AI productivity tool-enableable platform service tool gathering the one or more versions of firmware or configuration changes to one or more hardware components and the functional runtime firmware capabilities enabled or allowable under current configurations or firmware versions at the platform level. Since machine readable code instructions of the OTB AI productivity tool may be used by a plurality of platform type information handling systems, such as central processing unit (CPU)-based personal computers, ARM based devices, or others, determination of runtime firmware capabilities may be beneficial to customize registered firmware capabilities for without requiring entirely custom OTB AI productivity tool version in some embodiments.

These runtime firmware capabilities (also called capability intents and having capability intent values) may describe those functionalities of each of one or more versions of firmware for one or more hardware components that may be executed via the AI productivity tool-enableable platform service tool when interfacing with the OTB AI productivity tool. Natural language descriptions of the runtime firmware capabilities and any software capabilities of AI productivity tool-enableable software applications may be stored within a natural language capability database for comparison to received user query inputs, for example, in order to identify a software or runtime firmware capability most likely to address a user’s request within the received user query inputs.

As described below, some runtime firmware capabilities for hardware, including firmware drivers for the hardware components, are accessible as registered capabilities as part of the OTB AI productivity tool executing at the OS level but execution of the runtime firmware capabilities are executed at the information handling system platform level. Further, these firmware and hardware capabilities may be routinely updated or adjusted by a user, download of an updated version, changes to hardware configurations, or by an information technology decision maker (ITDM) managing an enterprise of information handling systems. A system is needed to routinely update the stored registered runtime firmware capabilities at the OTB AI productivity tool and executable by the various firmware and hardware components of an information handling system as those functional adjustments take place.

For example, an embedded controller operating at the platform level executes machine readable code instructions for the platform level capabilities gathering module to receive a notification that the battery has been removed. In such a scenario, the embedded controller executing machine readable code instructions for platform level capabilities gathering module may then register an updated list of runtime firmware capabilities via the AI productivity tool-enableable platform service tool interfacing with the OTB AI productivity tool to alter or remove battery-related firmware capabilities in an embodiment. Additionally, the capability intent values for those firmware capability descriptions for the runtime firmware capabilities to “minimize battery usage,” or to “optimize battery charging” are also omitted from the registered firmware capabilities at the OTB AI productivity tool since no action may be taken on the removed battery by firmware at the platform level. The registered list of capabilities having defined capability intent values for the capability descriptions at the OTB AI productivity tool at the OS level are tailored with updates generated by the platform level capabilities gathering module. In this way, the embedded controller executing machine readable code instructions for the AI productivity tool-enableable platform service tool may ensure that any commands to execute functionality of the registered runtime firmware capabilities by selection of a registered firmware capability at the OS level are in accordance with current versions of firmware or hardware component configurations at the platform level in embodiments herein.

An embedded controller in embodiments herein executing machine readable code instructions at a platform level, below the OS, for a platform level capability gathering module may receive automated notifications from versions of firmware or orchestrated by the AI productivity tool-enableable platform service tool as changes to firmware or hardware occur. The embedded controller executing machine readable code instructions for the platform level capability gathering module in an embodiment may communicate with the AI productivity tool-enableable platform service tool and the firmware for or one or more hardware components through several different available communication protocols. For example, a single embedded controller executing machine readable code instructions for the platform level capability gathering module and the AI productivity tool-enableable platform service tool may allow for communication with one or more versions of firmware for one or more hardware components via an inter-integrated circuit (I2C), a universal asynchronous receiver/transmitter (UART) communication protocol, or a universal serial bus (USB) communication protocol. As another example, the embedded controller executing machine readable code instructions for the platform level capability gathering module in an embodiment may communicate with another embedded controller or microcontroller executing machine readable code instructions for the AI productivity tool enableable platform service tool, or with one or more versions of firmware for one or more hardware components via an inter-integrated circuit (I2C), a universal asynchronous receiver/transmitter (UART) communication protocol, or a universal serial bus (USB) communication protocol. In still another example, embedded controller executing machine readable code instructions for the platform level capability gathering module in an embodiment may communicate with one or more hardware components via the system management bus (SMBus) communication protocol, the UART communication protocol, the USB communication protocol, or in compliance with an input output control system (IOCTL) protocol.

The embedded controller executing machine readable code instructions for the platform level capability gathering module may gather these notifications from the AI productivity tool-enableable platform service tool coordinating changes to firmware or hardware as well as from one or more versions of firmware for one or more hardware components via a plurality of communication protocols at the platform level with the embedded controller. The AI productivity tool-enableable platform service tool executing with the platform level capability gathering module may, thus, routinely or in real-time update, remove, or add registered capabilities for the AI productivity tool-enableable platform service tool depending on the notifications gathered to reflect newly added or enabled functionality, or removed or disabled functionality of firmware or hardware. These updated runtime firmware capabilities for the AI productivity tool enableable platform service tool, relating to firmware for one or more hardware components, may then be transmitted from the AI productivity tool-enableable platform service tool to the OTB AI productivity tool operating at the OS level via a single communication protocol. In an example embodiment, an Advanced Configuration and Power Interface (ACPI) communication protocol may be used governing communication between the OTB AI productivity tool and the AI productivity tool enableable platform service tool.

The platform level capabilities gathering module acting as a hub to gather, consolidate, and transmit, via the AI productivity tool enableable platform service tool, to the OTB AI productivity tool the routine or real-time updates reflecting current configurations, policies, or functionalities for the AI productivity tool-enableable platform service tool of the firmware for one or more hardware components. Transmission of these gathered updates occurs via a single communication protocol (ACPI) to update registration of runtime firmware capabilities at the OS level and alleviates the need for the hardware processor executing code instructions at the OS level for the OTB AI productivity tool to communicate with each of the one or more versions of firmware for one or more hardware components via the various communication protocols linking these hardware components to the embedded controller and then to the OS level hardware processor. This may increase efficiency and speed of the OTB AI productivity tool itself while maintaining updated and current registered firmware capabilities available across different platform types of information handling systems or when updates or changes are made to firmware or the hardware component configuration.

A hardware processor executing machine readable code instructions for a capability intent value generator embedding process of the OTB AI productivity tool may determine capability intent values associated with these natural language descriptions of the gathered runtime firmware capabilities received from the AI productivity tool-enableable platform service tool as they are updated for inclusion in the capability intent values database. These capability intent values are a mathematical representation, such as a vectorized capability intent value in a multi-axis vector space, of capability operations or services of software capabilities of AI productivity tool enableable software applications at the OS level as well as runtime firmware capabilities at the platform level in embodiments herein. Such capability intent values as vectors are used in a natural language processing method of execution of a large language model (LLM) for an OTB AI productivity tool to determine and correlate the user’s query intent or requested action within a user query input that takes into account the context or semantics of the words used within the user query input with one of a plurality of software capabilities of AI productivity tool enableable software applications or runtime firmware capabilities at the platform level.

Upon receipt of a user query input by the OTB AI productivity tool in embodiments herein, a hardware processor executes code instructions to determine a vectorized query input intent value for the user query input that is compared to the capability intent values. The hardware processor executing machine readable code instructions for a query intent to capability determination module in embodiments herein may then perform one or more similarity search methods to match the query input intent value with a software or firmware capability intent value in order to identify a responsive capability to address the user request within the user query input. The hardware processor executing code instructions for the OTB AI productivity tool may then instruct execution of the matching capability, via the AI productivity tool-enableable platform service tool which may now include runtime firmware capabilities available for matching in such a way that are updated and tailored to only reflect current hardware configuration and current firmware versions at the platform level.

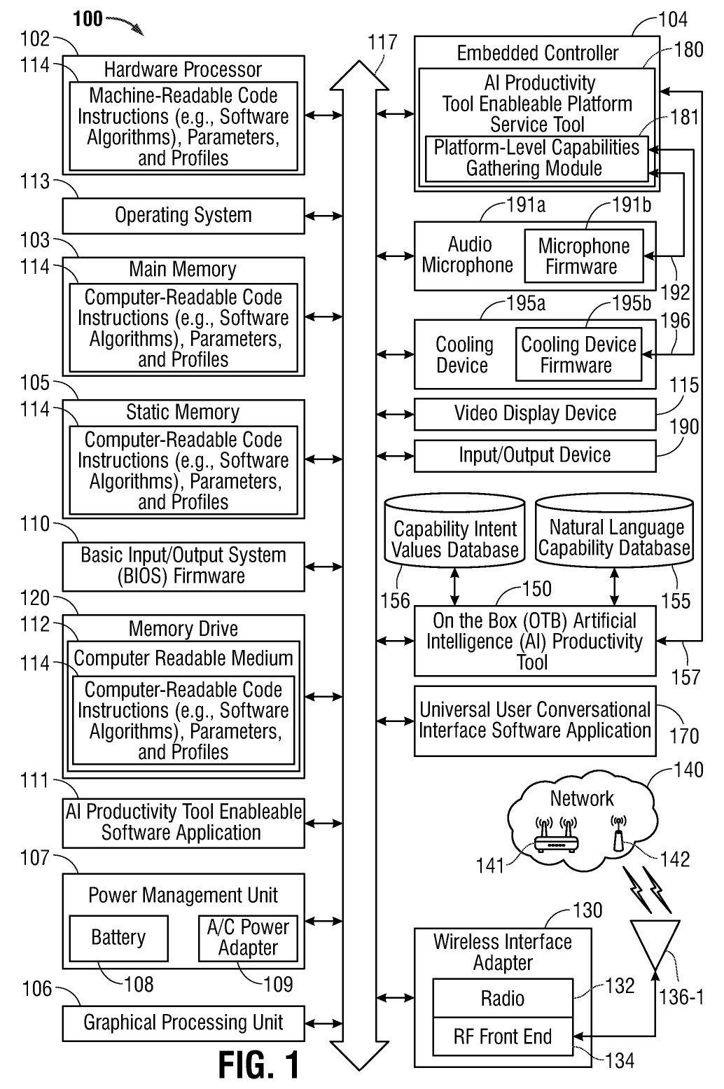

Turning now to the figures, FIG. 1 illustrates an information handling system 100 similar to the information handling systems according to several aspects of the present disclosure. As described herein, an on the box (OTB) artificial intelligence (AI) productivity tool 150 in an embodiment may execute at the operating system 113 level of an information handling system 100. The OTB AI productivity tool 150 may work in tandem with an agent, referred to herein as an AI productivity tool-enableable platform service tool 180, to allow user queries to trigger certain firmware capabilities for firmware for hardware components at a platform level. Examples of firmware may include microphone firmware 191b or cooling device firmware 195b, or firmware for hardware input/output devices 190 (e.g., input/output device 190, power management unit 107, display device 115, microphone 191a, or cooling device 195a). The runtime firmware capability actions at an information handling system platform level are declared and supported by firmware (e.g., 191b or 195b) for various hardware components (e.g., 191a or 195a, respectively) of the information handling system 100 for the AI productivity tool-enableable platform service tool 180 operating at the platform level of the information handling system 100. The platform level of the information handling system 100 includes operations and executions of an embedded controller or other controller hardware operating below the OS 113 of the information handling system.

A hardware processor 102 executing code instructions of the OTB AI productivity tool 150 in an embodiment may receive user queries via an input/output device 190 such as a keyboard, microphone, or video camera, described herein as user query inputs. The OTB AI productivity tool 150 may match received user query inputs to known available software capabilities of an AI productivity tool-enableable software applications 111 at the OS 113 level or available runtime firmware capabilities of the AI productivity tool-enableable platform service tool 180 at a platform level. Runtime firmware capabilities may relate to platform level functions affecting one or more versions of firmware (e.g., 191b or 195b) for one or more hardware components (e.g., 191a or 195a) executable at the platform level through execution by an embedded controller 104. The hardware processor 102 executing code instructions of the OTB AI productivity tool 150 may then direct execution of these software capabilities at the OS 113 level or firmware capabilities at the platform level via the AI productivity tool-enableable platform service tool 180 in response to a received user query input.

The hardware processor 102 executing machine readable code instructions for the OTB AI productivity tool 150 in an embodiment may only instruct performance of registered firmware capabilities at the OS 113 level via the AI productivity tool-enableable platform service tool 180 that are in accordance with current versions, configurations, and policies of the one or more versions of firmware (e.g., 191b or 195b), for the one or more hardware components (e.g., 191a or 195a). To do so, registered firmware capabilities at the OTB AI productivity tool 150 in the OS 113 level may need to be updated in accordance with changes or updates to current versions, configurations, and policies of the one or more versions of firmware (e.g., 191b or 195b) for the one or more hardware components (e.g., 191a or 195a). This process includes gathering, either in real-time or prior to execution of the OTB AI productivity tool 150, via the AI productivity tool-enableable platform service tool 180 functional capabilities enabled or allowable under current configurations or policies for the current versions of firmware (e.g., 191b or 195b) and configurations of hardware components (e.g., 191a or 195a). These runtime firmware capabilities may describe those functionalities of each of one or more versions of firmware (e.g., 191b or 195b) for one or more hardware components (e.g., 191a or 195a) that may be orchestrated via the AI productivity tool-enableable platform service tool 180 interfacing with the OTB AI productivity tool 150.

Both firmware capabilities and software capabilities of one or more AI productivity tool-enableable software applications 111 executable at the information handling system may be available capabilities registered for access by the OTB AI productivity tool 150 in embodiments herein. These software and firmware capabilities may include natural language descriptions of the registered available capabilities that may be stored within a natural language capability database 155 in some embodiments for comparison to received user query inputs, for example, in order to identify a capability most likely to address a user’s request within the received user query inputs. Further, registered available software and firmware capabilities may have embedded capability intent values stored in a capability intent values database 156 for comparison to embedded query intent values of the received user query inputs, for example, in order to identify a responsive software capability or firmware capability most likely to address a user’s request within the received user query inputs in embodiments herein.

As described below, one or more registered firmware capabilities, including firmware drivers for the hardware components, are accessible as part of the OTB AI productivity tool 150 executing at the OS 113 level and may be accessed via the AI productivity tool-enableable platform service tool 180 for firmware managed and executed at the information handling system platform level. Further, these firmware capabilities or hardware may be routinely updated or adjusted by a user, an updated version, or by an information technology decision maker (ITDM) managing enterprise information handling systems including 100. The embedded controller 104 may execute machine readable code instructions of the platform level capabilities gathering module 181 to routinely gather notifications of updates or changes to firmware for one or more hardware components or for hardware configuration changes reported on a variety of communication protocols to the embedded controller 104. These notifications of updates or changes to firmware for one or more hardware components or for hardware configuration changes are gathered by the platform level capabilities gathering module 181 to update the stored registered firmware capabilities in the natural language capabilities database 155 of the OTB AI productivity tool 150 at the OS 113 level.

Execution of machine readable code instructions of the AI productivity tool-enableable platform service tool 180 may update the registered firmware capabilities via updates gathered by the platform level capabilities gathering module 181as those functional adjustments take place in embodiments. By tailoring the registered list of firmware capabilities in the natural language capabilities database 155 as well as associated firmware capability intent values for the capability descriptions at the capabilities intent values database 156, the embedded controller 104 executing machine readable code instructions for the AI productivity tool-enableable platform service tool 180 ensures registered firmware capabilities for the OTB AI productivity tool 150 are in accordance with current hardware configuration and policies, and current versions and functionality platform level capabilities gathering module 181 for one or more versions of firmware (e.g., 191b or 195b) or one or more hardware components (e.g., 191a or 195a) operating on the information handling system 100 via the AI productivity tool-enableable platform service tool 180.

An embedded controller 104 in an embodiment executing machine readable code instructions at a platform level, below the OS 113, for the information handling system 100 for the platform level capability gathering module 181 to receive automated notifications from each of one or more versions of firmware (e.g., 191b or 195b), or one or more hardware components (e.g., 191a or 195a) of the information handling system 100 as those changes occur. The embedded controller 104 executing machine readable code instructions for the platform level capability gathering module 181 in an embodiment may communicate with each of the one or more versions of firmware (e.g., 191b or 195b), or one or more hardware components (e.g., 191a or 195a) through several different available communication protocols in various embodiments. For example, an embedded controller 104 executing machine readable code instructions for the platform level capability gathering module 181 and the AI productivity tool-enableable platform service tool 180 may allow for communication with another embedded controller or one or more versions of firmware (e.g., 191b or 195b) via links 192 or 196 using one or more of an inter-integrated circuit (I2C), a universal asynchronous receiver/transmitter (UART) communication protocol, or a universal serial bus (USB) communication protocol in an example embodiment. In still another example, embedded controller 104 executing machine readable code instructions for the platform level capability gathering module 181 in an embodiment may communicate with one or more hardware components (e.g., 191a or 195a) via links 192 or 196 using one or more of the system management bus (SMBus) communication protocol, the UART communication protocol, the USB communication protocol, or in compliance with an input output control system (IOCTL) protocol in other embodiments.

The embedded controller 104 executing machine readable code instructions for the platform level capability gathering module 181 may gather these notifications from each of the one or more versions of firmware (e.g., 191b or 195b) for the AI productivity tool-enableable platform service tool 180 to transmit updates or changes to firmware capabilities registered at the OS 113 level with the OTB AI productivity tool 150. The AI productivity tool-enableable platform service tool 180 may communicate to the OS 113 level OTB AI productivity tool 150 to update registrations of the runtime firmware capabilities for firmware (e.g., 191b or 195b) for one or more hardware components (e.g., 191a or 195a), routinely or in real-time. Communication to the OS 113 level OTB AI productivity tool 150 may update, remove, or add registered firmware capabilities for access by the OTB AI productivity tool 150 to respond to user query inputs to reflect newly added or enabled functionality, or removed or disabled functionality of firmware or hardware component configurations at the platform level of the information handling system. These updated firmware capabilities for one or more versions of firmware (e.g., 191b or 195b) or for configurations of one or more hardware components (e.g., 191a or 195a) may then be transmitted from the AI productivity tool-enableable platform service tool 180 to the OTB AI productivity tool 150 operating at the OS 113 level via a single communication protocol link 157, such as an Advanced Configuration and Power Interface (ACPI) communication protocol governing communication between the OTB AI productivity tool 150 and the AI productivity tool-enableable platform service tool 180. This same protocol may be used in communicating instructions from the OTB AI productivity tool 150 to execute responsive firmware capabilities managed by the AI productivity tool-enableable platform service tool 180 at the platform level in embodiments herein. Thus, the platform level capabilities gathering module 181 acts as a hub to gather and consolidate the routine or real-time updates reflecting current configurations, policies, or functionalities to the AI productivity tool-enableable platform service tool 180 for transmission to the OTB AI productivity tool 150 via the single communication protocol (e.g., ACPI). This alleviates the need for the hardware processor 102 executing code instructions at the OS 113 level for the OTB AI productivity tool 150 to communicate with each of the one or more versions of firmware (e.g., 191b or 195b), or one or more hardware components (e.g., 191a or 195a) via the various communication protocols linking these devices or controllers to the OS 113 level hardware processor 102, which may increase efficiency and speed of the OTB AI productivity tool 150 itself.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, other hardware controllers, or any combination thereof. Additional components of the information handling system 100 may include one or more storage devices such as static memory 105 or drive unit 120. The information handling system 100 may include or interface with one or more communications ports for communicating with external devices, as well as an input/output (IO) device 190, a video/graphics display device 115, an audio microphone 183a for recording user communications, or any combination thereof. Portions of an information handling system 100 may themselves be considered information handling systems 100.

Information handling system 100 may include devices or modules that embody one or more of the hardware devices or hardware processing resources executing machine readable code instructions for one or more systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood any or all portions of machine readable code instructions (e.g., software or firmware algorithms), parameters, and profiles 114 may operate on a plurality of information handling systems 100. In a specific embodiment, machine readable code instructions for the OTB AI productivity tool 150, a universal user conversational interface software application software application 170, an AI productivity tool-enableable platform service tool 180, a platform level capabilities gathering module 181, one or more AI productivity tool enableable software applications 111, and firmware (e.g., 191b and 195b) may execute locally at the information handling system 100, or on the box.

The information handling system 100 may include the hardware processor 102 such as a central processing unit (CPU) or other hardware processing resources. Any of the hardware processing resources may operate to execute machine readable code instructions 114 that are either firmware or software code. Moreover, the information handling system 100 may include memory such as main memory 103, static memory 105, and disk drive unit 120 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, EC 104, GPU 106, or any other hardware processing device. The information handling system 100 may also include one or more buses 117 operable to transmit communications between the various hardware components such as any combination of various I/O devices 190, 183, 186, as well as between hardware processors 102, an EC 104, GPU 106 or other, the operating system (OS) 113, the basic input/output system (BIOS) 110, the wireless interface adapter 130, or a radio module 132, among other components described herein. In an embodiment, the hardware processor 102, EC 104, and/or GPU 106 may execute one or more bus drivers in order to transmit this data between the information handling system 100 and the input/output devices 190 described herein. As described herein, the information handling system 100 further includes a video/graphics display device 115. The video/graphics display device 115 in an embodiment may function as a liquid crystal display (LCD), an organic light emitting diode (OLED), a flat panel display, or a solid-state display. It is appreciated that the video/graphics display device 115 may be wired or wireless and may be an external video/graphics display device 115 that allows a user to increase the desktop area by extending the desktop in an embodiment.

A network interface device of the information handling system 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system 100 to a network 140 via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100. Wireless interface adapter 130 may include one or more radio frequency (RF) subsystems (e.g., radio 132) with transmitter/receiver circuitry, modem circuitry, one or more antenna RF front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth ® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130.

The information handling system 100 may include a set of instructions 114 that may be executed to cause the computer system to perform any one or more of the methods or computer-based functions disclosed herein. For example, machine readable code instructions 114 may be executed by a hardware processor 102, GPU 106, EC 104 or any other hardware processing resource and may include software agents, or other aspects or components used to execute the methods and systems described herein. Various software modules comprising application machine readable code instructions 114 may be coordinated by an OS 113, and/or via an application programming interface (API) include a unified device API described herein. An example OS 113 may include Windows ®, Android ®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 120 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 120 during execution by the hardware processor 102, EC 104, or GPU 106 of information handling system 100.

Main memory 103 or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 120 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 120, the hardware processor 102 (e.g., CPU), the EC 104, the GPU 106, a video/graphic display device 115, or other wired I/O devices 183, 186, or 190 and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 105 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

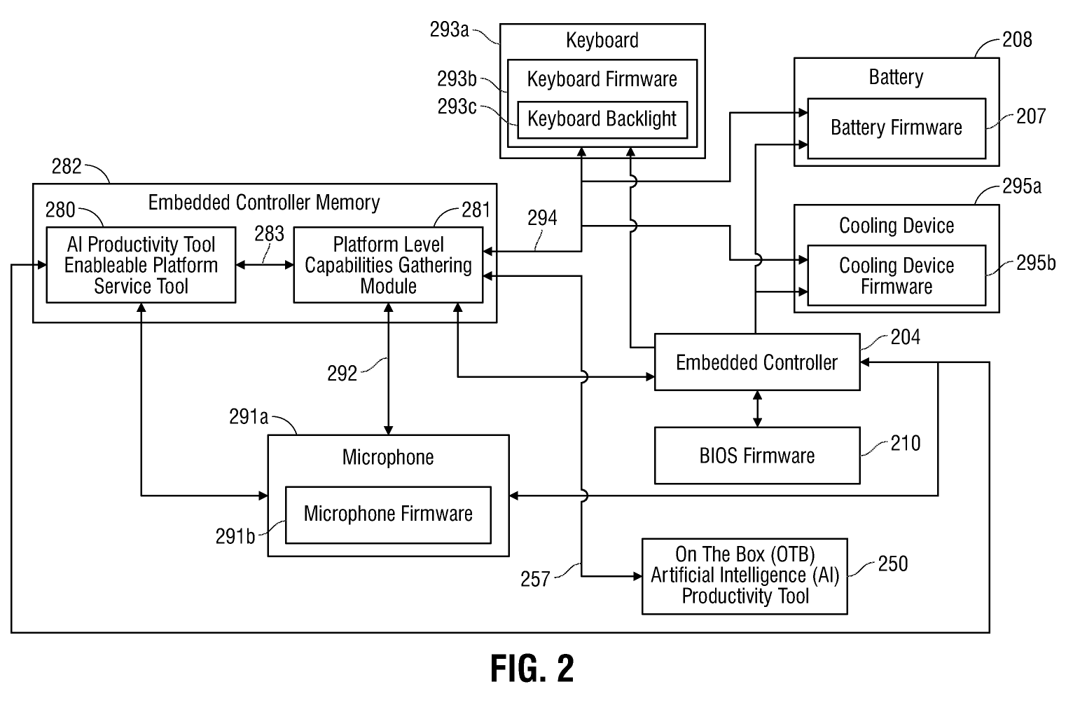

FIG. 2 is a block diagram illustrating an embedded controller executing machine readable code instructions for a platform-level AI productivity tool-enableable platform tool for automatically updating firmware capabilities selectable by an OTB AI productivity tool operating at an OS level for an information handling system to reflect current configurations, functionality, and policies for firmware or configuration of hardware components according to an embodiment of the present disclosure. As described herein, machine readable code instructions for the OTB AI productivity tool 250 in an embodiment may execute at an operating system level of an information handling system and may work in tandem with an AI productivity tool-enableable platform service tool 280 executing at the platform level to allow user queries to trigger certain firmware capability actions for hardware components or firmware at in information handling system platform level. These firmware capability actions are declared and supported by firmware, such as battery firmware 207, microphone firmware 291b, keyboard firmware 293b, cooling device firmware 295b or other firmware for various hardware components, such as battery 208, microphone 291a, keyboard 293a, cooling device 295a or other components of the information handling system. Coordination of these firmware capability actions may be by the AI productivity tool-enableable platform service tool 280 operating at the platform level, below the OS of the information handling system, for interface with the OTB AI productivity tool 250 at the OS level. These are only a few examples of hardware components and firmware managed by the AI productivity tool-enableable platform service tool 280 and the OTB AI productivity tool 250. For example, a battery 208 may also involve controls by a PMU (e.g., 107 in FIG. 1) with a PMU controller executing PMU firmware (not shown) in an example embodiment. It is contemplated that any type of internal or external hardware components, peripheral device, or firmware therefor that is in communication with the AI productivity tool-enableable platform service tool 280, or the platform level capabilities gathering module 281, may be controlled thereby in response to received user query inputs as described in various embodiments herein.

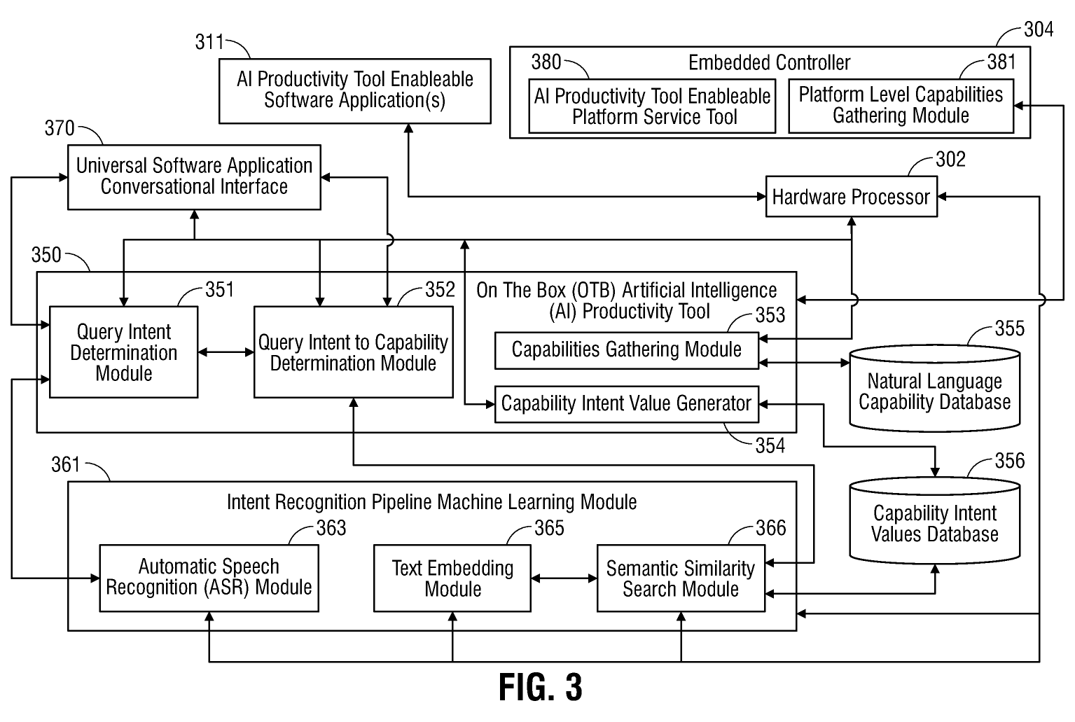

A hardware processor executing code instructions of the OTB AI productivity tool 250 in an embodiment herein may receive user query inputs via an input/output device such as a keyboard 293a, or microphone 291a, as described in greater detail below with respect to FIG. 3. The OTB AI productivity tool 250 may match received user query inputs to known, available capabilities from a natural language capability database or capability intent values database at the OS level. This may include registered firmware capabilities at natural language capability database or capability intent values database of the AI productivity tool-enableable platform service tool 280 for firmware capability actions controlling one or more versions of firmware (e.g., 207, 291b, 293b, or 295b), or one or more hardware components (e.g., 208, 291a, 293a, or 295a) executable at the platform level. The hardware processor executing code instructions of the OTB AI Productivity tool 250 may then direct execution of these firmware capability actions at the platform level, below the OS level, via communication to and coordination by an embedded controller 204 executing the AI productivity tool-enableable platform service tool 280 in embodiments herein. A single communication protocol 257, such as an Advanced Configuration and Power Interface (ACPI) communication protocol, may be used between the hardware processor executing the OTB AI Productivity tool 250 to instruct a selected responsive firmware capability be executed by the embedded controller 204 executing the AI productivity tool-enableable platform service tool 280 according to embodiments herein.

Prior to such a process and prior to a user providing such a user query input into an OTB AI productivity tool 250, the AI productivity tool-enableable platform service tool 280 may register with the OTB AI productivity tool 250 a list of firmware capabilities achievable by each of the one or more versions of firmware (e.g., 207, 291b, 293b, 295b), or one or more hardware components (e.g., 208, 291a, 293a, 295a). For example, the firmware capabilities registered and stored at the OTB AI productivity tool 250 may describe functionalities of battery firmware 207 for the battery 208 or a PMU controller executing firmware controlling battery 208 via the PMU and may include various power mode settings including a power saving mode. In another example, the firmware capabilities registered and stored at the OTB AI productivity tool 250 may describe functionalities of the keyboard 293a or corresponding firmware 293b executing on a firmware controller to power on or off a keyboard backlight 293c. In still another example, the firmware capabilities registered and stored at the OTB AI productivity tool 250 may describe functionalities of the cooling device firmware 295b executed by a thermal controller to adjust settings for the cooling device 295a according to a user selectable thermal table (USTT), such as by increasing or decreasing fan speed.

Such a registration of firmware capabilities at an OTB AI productivity tool, especially those that involve adjusting functionality of hardware components (e.g., 208, 291a, 293a, 295a) at the information handling system may not take into account current configurations and policies for changes to those hardware components (e.g., 208, 291a, 293a, 295a) or current versions of firmware (e.g., 207, 291b, 293b, 295b) which may disallow or make perfunctory such firmware capabilities or may add or modify existing firmware capabilities. For example, an AI productivity tool-enableable platform service tool 280 may have registered a firmware capability with the OTB AI productivity tool 250 at the OS level for optimizing hardware component performance, such as battery 208, but such an AI productivity tool-enableable platform service tool 280 and the firmware or the hardware component, such as battery firmware 207, PMU firmware, or the battery hardware component 280, may not be capable of performing that capability due to changes or updates to the firmware or hardware components. For example, a battery 208 or other hardware component may have been removed or a version of the firmware (e.g., 207) may have been recently added or altered within the information handling system to change available firmware capability actions at the platform level. Thus, each time such a hardware component (e.g., 208, 291a, 293a, 295a) configuration changes or a version of firmware (e.g., 207, 291b, 293b, 295b) is changed, the actual list of firmware capabilities performable by the AI productivity tool-enableable platform service tool 280, and indirectly by the OTB AI productivity tool 250 may change. However, this may not be reflected by the list of firmware capabilities registered at the OTB AI productivity tool 250 instructing execution of such firmware capabilities from among a plurality of registered software and firmware capabilities.

A hardware processor for an information handling system executing machine readable code instructions for AI productivity tool-enableable platform service tool 280 in embodiments herein may address these issues by only instructing performance of updating firmware capabilities registered at the OTB AI productivity tool 250 by gathering updates or changes to one or more versions of firmware (e.g., 207, 291b, 293b, 295b), or one or more configurations of hardware components (e.g., 208, 291a, 293a, 295a) to be in accordance with current versions, configurations, and policies. This process includes gathering, either in real-time or prior to execution of the OTB AI productivity tool 250, the firmware capability actions executable at one or more versions of firmware (e.g., 207, 291b, 293b, 295b), or one or more hardware components (e.g., 208, 291a, 293a, 295a) by the AI productivity tool-enableable platform service tool 280. These firmware capability actions may describe those functionalities of each of the one or more versions of firmware (e.g., 207, 291b, 293b, 295b), or one or more hardware components (e.g., 208, 291a, 293a, 295a) that may be executable via the AI productivity tool-enableable platform service tool 280 when interfacing with the OTB AI productivity tool 250. However, the one or more versions of firmware (e.g., 207, 291b, 293b, 295b), or one or more hardware components (e.g., 208, 291a, 293a, 295a) may be in communication with the embedded controller executing the AI productivity tool-enableable platform service tool 280 via a variety of communication protocols.

Some hardware or firmware capabilities, including firmware drivers for the hardware components (e.g., 208, 291a, 293a, 295a) are accessible as part of the OTB AI productivity tool 250 executing at the OS level as firmware capability actions for firmware managed by the AI productivity tool-enableable platform service tool 280 and executed at the information handling system platform level. Natural language descriptions of the firmware capabilities may be registered and stored within a natural language capability database of the OTB AI productivity tool 250 with firmware capability intent values stored at a capability intent values database for comparison to received user query inputs, for example, in order to identify a software or firmware capability most likely to address a user’s request within the received user query inputs. Further, these firmware capabilities may be routinely updated or adjusted by a user, a version update, or by an information technology decision maker (ITDM) managing an enterprise of information handling systems. In some cases, the embedded controller 204 executing machine readable code instructions for the AI productivity tool-enableable platform service tool itself may perform such a functionality adjustment that adds or removes functionality of various firmware (e.g., 207, 291b, 293b, 295b) or hardware components (e.g., 208, 291a, 293a, 295a).

An embedded controller executing machine readable code instructions for a platform level capabilities gathering module 281 in an embodiment may, routinely or in real-time, receive notification of updates or changes to firmware capabilities executable by the various firmware (e.g., 207, 291b, 293b, 295b) and hardware components (e.g., 208, 291a, 293a, 295a) of an information handling system as those functional adjustments take place. For example, battery firmware 207 or PMU firmware for control of a battery 208 that is generally capable of optimizing performance of battery 208 may have an initial list of firmware capabilities performing firmware capability actions to minimize the battery usage or to optimize battery charging. Upon updating or adjustment of functionality of battery 208 (e.g., removal of the battery 208), battery firmware 207 or PMU firmware by a user, an updated version, or by an ITDM, this initial firmware capability may be modified or removed (e.g., because the battery has been removed). The battery firmware 207 or PMU firmware for battery 208 may automatically transmit a notification of functionality adjustment indicating this update or adjustment to the embedded controller 204 executing the platform level capabilities gathering module 281 via any established communication protocol. The embedded controller 204 executing machine readable code instructions for the platform level capabilities gathering module 281 in such an example embodiment may gather functional adjustments from plural communication protocols from various firmware (e.g., 207, 291b, 293b, 295b) and hardware components (e.g., 208, 291a, 293a, 295a). Then, the AI productivity tool-enableable platform service tool 280 may determine which registered firmware capabilities are modified, added or removed and transmit an updated firmware capability or updated list of firmware capabilities to be registered with the OTB AI productivity tool 250 at the OS level. For example, the AI productivity tool-enableable platform service tool 280 may update a list of firmware capabilities that omits a natural language description for a firmware capability to minimize battery usage or to optimize battery charging due to the notified functionality adjustment in hardware component configuration for removal of the battery in an embodiment.

In another example, one or more versions of battery firmware 207 or PMU firmware for control of battery 208 may be generally incapable platform level actions for minimizing usage of battery 208 or optimizing battery charging for battery 208. The AI productivity tool-enableable platform service tool 280 may have registered an initial list of capabilities that omits NLP defined capability intent values for the capability descriptions to minimize battery usage or to optimize battery charging. Upon updating or adjustment of the battery 208 (e.g., replacement of the battery 208), battery firmware 207, or PMU firmware controller operation of battery 208 by a user, a version update, or by an ITDM to add or enable this capability, the AI productivity battery firmware 207 or PMU firmware for battery 208 may automatically transmit a notification of functionality adjustment indicating this update or adjustment to the platform level capabilities gathering module 281. The embedded controller 204 executing machine readable code instructions for the AI productivity tool-enableable platform service tool 280 may determine which registered firmware capabilities are modified, added or removed and transmit an updated firmware capability or updated list of firmware capabilities to be registered with the OTB AI productivity tool 250 at the OS level. For example, the AI productivity tool-enableable platform service tool 280 may update a list of firmware capabilities that adds a natural language description for a firmware capability to minimize battery usage or to optimize battery charging due to the notified functionality adjustment to update versions of the battery firmware 207 or PMU firmware in an embodiment.

As another example, firmware 293b or keyboard 293a executable via an AI productivity tool-enableable platform service tool 280 may be generally capable of modulating power to a keyboard backlight 293c may have an initial list of firmware capabilities having natural language defined firmware capability intent values for the firmware capability descriptions that includes “turn off keyboard backlight,” “turn on keyboard backlight,” or “optimize keyboard backlight for power consumption.” Upon updating or adjustment of functionality for the keyboard 293a, keyboard firmware 293b, or policies for execution of the same this initial capability may be modified for a firmware capability action, for example to adjust levels of keyboard backlight between fully on and off. The keyboard firmware 293b for keyboard 293a may automatically transmit a notification of functionality adjustment indicating this update or adjustment to the platform level capabilities gathering module 281 in an established communication protocol between the embedded controller 205 and keyboard 293a or a keyboard controller. The embedded controller 204 executing machine readable code instructions for the AI productivity tool-enableable platform service tool 280 in such an example embodiment may determine firmware capabilities that are adjusted, removed, or modified and then transmit an updated firmware capability or updated list of firmware capabilities for registration with the OTB AI productivity tool 250. For example, the AI productivity tool-enableable platform service tool 280 determines that firmware capability action for a dimmer function to adjust levels of keyboard backlight between fully on and off may be added to or may replace firmware capabilities described in natural language descriptions for “turn off keyboard backlight” or “turn on keyboard backlight” based on the notified functionality adjustment to the keyboard firmware 293.

In another example, firmware 295b for cooling device 295a may have a firmware capability that is generally capable of adjusting settings for the cooling device 295a according to a USTT, such as by increasing or decreasing fan speed, via interface of the AI productivity tool-enableable platform service tool 280 with the OTB AI productivity tool 250. The AI productivity tool-enableable platform service tool 280 may have registered an initial list of firmware capabilities for firmware functions that include cooling the information handling system according to the USTT, increasing or decreasing fan speed or operation according to the USTT, or optimizing fan speed for power consumption according to the USTT. Upon updating or adjustment to the USTT in the firmware 295b for the cooling device 295a by a user, a version update, or by an ITDM in an embodiment the cooling device firmware 295b for cooling device 295a may automatically transmit a notification of functionality adjustment indicating this update or adjustment to the platform level capabilities gathering module 281. The embedded controller 204 executing machine readable code instructions for the platform level capabilities gathering module 281 in such an example embodiment may receive such a functionality adjustment notification via a communication protocol between the embedded controller 204 and a thermal controller of the cooling device 295a. The embedded controller 204 executing machine readable code instructions for the AI productivity tool-enableable platform service tool 280 may determine which registered firmware capabilities are modified, added or removed and transmit an updated firmware capability or updated list of firmware capabilities to be registered with the OTB AI productivity tool 250 at the OS level. For example, the AI productivity tool-enableable platform service tool 280 may update a list of firmware capabilities that adds a natural language description for a firmware capability to cool the information handling system according to the updated USTT version, increase or decrease fan speed or operation according to the updated USTT version, or optimizing fan speed for power consumption according to the updated USTT version based on the notified functionality adjustment of the USTT update.

The embedded controller 204 in an embodiment, executing machine readable code instructions at a platform level, below the OS for the information handling system, for a platform level capability gathering module 281 may receive these automated functionality adjustment notifications from each of the one or more versions of firmware (e.g., 207, 291b, 293b, 295b), or one or more hardware components (e.g., 208, 291a, 293a, 295a) as those changes occur through several different available communication protocols between the embedded controller 204 and various controllers of the one or more hardware components (e.g., 208, 291a, 293a, 295a). For example, a single embedded controller 204 or plural embedded controllers 204 executing machine readable code instructions for the platform level capability gathering module 281 and the AI productivity tool-enableable platform service tool 280 may allow for communication between them via link 283 using a universal asynchronous receiver/transmitter (UART) communication protocol in an embodiment. As another example embodiment, the embedded controller 204 executing machine readable code instructions for the platform level capability gathering module 281 in an embodiment may communicate with another embedded controller executing machine readable code instructions for the platform level capability gathering module 281 or microcontroller of one or more hardware components (e.g., 208, 291a, 293a, 295a) via link 284 using an inter-integrated circuit (I2C), a universal asynchronous receiver/transmitter (UART) communication protocol, or a universal serial bus (USB) communication protocol. In yet another example embodiments, the embedded controller 204 executing machine readable code instructions for the platform level capability gathering module 281 in an embodiment may communicate with one or more versions of firmware (e.g., 207, 291b, 293b, 295b) via a plurality of links (e.g., 292 and 294) using an I2C, UART, or USB communication protocol. In still other example embodiments, embedded controller 204 executing machine readable code instructions for the platform level capability gathering module 281 in an embodiment may communicate with one or more hardware components (e.g., 208, 291a, 293a, 295a) via a plurality of links (e.g., 292 and 294) using the system management bus (SMBus) communication protocol, the UART communication protocol, the USB communication protocol, or in compliance with an input output control system (IOCTL) protocol.

The embedded controller 204 executing machine readable code instructions for the platform level capability gathering module 281 may gather these notifications from each of the one or more versions of firmware (e.g., 207, 291b, 293b, 295b), or one or more hardware components (e.g., 208, 291a, 293a, 295a) routinely or in real-time. The embedded controller may then execute the AI productivity tool-enableable platform service tool 280 to update, remove, or add registered firmware capabilities at the OTB AI productivity tool to reflect newly added or enabled functionality, or removed or disabled functionality. In this way, selection of a responsive firmware capability to a user query input by the OTB AI productivity tool may interface with the AI productivity tool-enableable platform service tool 280 for execution of firmware capability action with updated versions and hardware configurations for the one or more versions of firmware (e.g., 207, 291b, 293b, 295b), or one or more hardware components (e.g., 208, 291a, 293a, 295a) available at the platform level in embodiments herein. These updated firmware capabilities for the one or more versions of firmware (e.g., 207, 291b, 293b, 295b) or one or more hardware components (e.g., 208, 291a, 293a, 295a) may then be transmitted from the AI productivity tool-enableable platform service tool 280 to the OTB AI productivity tool 250 operating at the OS level via a link 257 using a single communication protocol in an embodiment.

For example, the single communication protocol for link 257 may be an Advanced Configuration and Power Interface (ACPI) communication protocol in an embodiment governing communication between hardware processor (e.g. 102 of FIG. 1) executing the OTB AI productivity tool 250 and the embedded controller 204 executing the AI productivity tool-enableable platform service tool 280. Thus, the platform level capabilities gathering module 281 and the AI productivity tool-enableable platform service tool 280 act as a hub to gather, consolidate, and transmit to the OTB AI productivity tool 250 the routine or real-time updates reflecting current configurations, policies, or functionalities for the firmware capabilities via a single communication protocol (e.g., ACPI). This alleviates the need for the hardware processor executing code instructions at the OS level for the OTB AI productivity tool 250 to communicate with each of one or more versions of firmware (e.g., 207, 291b, 293b, 295b), or one or more hardware components (e.g., 208, 291a, 293a, 295a) as well as the AI productivity tool-enableable platform service tool 280 via the plurality of various communication protocols linking these devices or controllers to the OS level hardware processor. Additionally, the single communication link 257, such as the under the ACPI communication protocol, may be used between hardware processor executing the OTB AI productivity tool 250 and the embedded controller 204 executing the AI productivity tool-enableable platform service tool 280 when a selected, responsive firmware capability is to execute firmware functionality in response to the user query input via interface with the AI productivity tool-enableable platform service tool 280. Such embodiments may increase efficiency and speed of the OTB AI productivity tool 250 itself and use of the hardware processor (e.g., 102 of FIG. 1).

Upon receipt of a user query input by the OTB AI productivity tool 250 in an embodiment, as described in greater detail below with respect to FIG. 3, a hardware processor executing code instructions of the OTB AI productivity tool 250 may then perform one or more similarity search methods to identify a responsive software or firmware capability to a user query input, including a firmware capability given within the most recently updated list of firmware capabilities received from the AI productivity tool-enableable platform service tool 280. The hardware processor executing code instructions for the OTB AI productivity tool may then instruct execution of the matching firmware capability, via communication and interface with the AI productivity tool-enableable platform service tool 280 using the single communication protocol link 257. Because the firmware capabilities available for matching in such a way are tailored to only reflect current hardware (e.g., 208, 291a, 293a, 295a) configuration and policies, and current versions and functionality of the AI productivity tool-enableable platform service tool 280 and firmware (e.g., 207, 291b, 293b, 295b), the embedded controller 204 executing machine readable code instructions for the platform level capabilities gathering module 281 may ensure that any commands to execute a capability via the AI productivity tool-enableable platform service tool 280 are in accordance with current hardware (e.g., 208, 291a, 293a, 295a) configuration and policies, and current versions and functionality of the firmware (e.g., 207, 291b, 293b, 295b) at the platform level.

FIG. 3 is a block diagram illustrating an on the box (OTB) AI productivity tool for performing a semantic similarity search to identify a best match firmware or software capability, including updated firmware capabilities managed by an AI productivity tool enableable platform service tool for a received user query input requesting action on behalf of an information handling system according to an embodiment of the present disclosure. As described herein, upon receipt of a user query input by the OTB AI productivity tool 350 in an embodiment, a hardware processor 302 executing code instructions of the OTB AI productivity tool 350 may perform one or more similarity search methods to identify a software capability of one or more AI productivity tool-enableable software applications 311 or a firmware capability given within the most recently updated list of firmware capabilities received from the AI productivity tool-enableable platform service tool 380.

Firmware capabilities relate to platform level firmware capability actions to control one or more versions of firmware (e.g., 207, 291b, 293b, 295b of FIG. 2) for one or more hardware components (e.g., 208, 291a, 293a, 295a of FIG. 2) that may closely correspond and can address the user request within the user query input. The hardware processor 302 executing code instructions for the OTB AI productivity tool 350 may then instruct execution of a matching firmware capability at the platform level via an embedded controller executing the AI productivity tool-enableable platform service tool 380. The firmware capabilities available for matching in such a way are tailored to only reflect current hardware (e.g., 208, 291a, 293a, 295a of FIG. 2) configuration and policies and current versions and functionality of the AI productivity tool-enableable platform service tool 380 and firmware (e.g., 207, 291b, 293b, 295b of FIG. 2) via updating to the registered firmware capabilities at the OTB AI productivity tool 350 at the OS level. Thus, an embedded controller 304 executing machine readable code instructions for a platform level capabilities gathering module 381 may ensure that any commands to execute a responsive firmware capability via the AI productivity tool-enableable platform service tool 380 are in accordance with current hardware (e.g., 208, 291a, 293a, 295a of FIG. 2) configuration and policies, and current versions and functionality of the AI productivity tool-enableable platform service tool 380 and firmware (e.g., 207, 291b, 293b, 295b of FIG. 2) according to embodiments herein.

The OTB AI productivity tool 350 in an embodiment may receive, via a universal user conversational interface software application 370 or other interface, a voice, image, or text input from a user, described herein as a user query input, that requests actions or services of the AI productivity tool 350. These actions or services may include software capabilities of one or more AI productivity tool-enableable software applications 311 executing at the OS level in some embodiments. These actions or services may also include firmware capabilities executable through the AI productivity tool-enableable platform service tool 380 for one or more versions of firmware (e.g., 207, 291b, 293b, 295b of FIG. 2), or one or more hardware components (e.g., 208, 291a, 293a, 295a of FIG. 2). A hardware processor 302 executing code instructions of the OTB AI productivity tool 350 in an embodiment may match these received user query inputs to known software and firmware capabilities, including most recently updated firmware capabilities received from the AI productivity tool-enableable platform service tool 380 pursuant to updates or changes to firmware or hardware detect by the platform level capabilities gathering module 381 in embodiment herein. An embedded controller executing machine readable code instructions of the AI productivity tool-enableable platform service tool 380 may initially publish and routinely update a list of recognized firmware capabilities for firmware functionalities that may be performed at the platform level during execution of the one or more versions of firmware (e.g., 207, 291b, 293b, 295b of FIG. 2) for one or more hardware components (e.g., 208, 291a, 293a, 295a of FIG. 2).

A query input received by the OTB AI productivity tool 350 is processed into a query intent vector value for semantic or lexical matching with available to firmware or software capabilities in the natural language capabilities database 355 or the capability intent values database 356 in embodiments. Updated firmware capabilities registered from the AI productivity tool-enableable platform service tool 380 are provided text descriptors that may be processed into vectorized capability intent values in a multi-axis vector space via embedding algorithm applied to the natural language descriptions of the updated firmware capabilities. These embedded vectorized capability intent values for both software capabilities and updated firmware capabilities are mathematical representations that may be correlated by a semantic similarity matching algorithm to a query intent value generated via an embedding a user query input to select a responsive software or firmware capability that is a best match or meets a threshold similarity search score to be responsive to a user query input from a user.

This process of an execution of the OTB AI productivity tool 350 includes receiving registration of updated firmware capabilities from the AI productivity tool-enableable platform service tool 380 pursuant to gathering functional adjustments via the platform level capabilities gathering module 381 for routinely updated one or more versions of firmware (e.g., 207, 291b, 293b, 295b of FIG. 2), or one or more configurations of hardware components (e.g., 208, 291a, 293a, 295a of FIG. 2) as described in greater detail above with respect to FIG. 2. These updated firmware capabilities for the one or more versions of firmware (e.g., 207, 291b, 293b, 295b of FIG. 2) or one or more hardware components (e.g., 208, 291a, 293a, 295a of FIG. 2) may be stored within the natural language capability database 355 or embedded in firmware capability intent values in the capability intent values database 356 for comparison to received user query inputs, for example, along with software capabilities of one or more AI productivity tool-enableable software applications 311 available at the OS level.

The hardware processor 302 executing machine readable code instructions of the OTB AI productivity tool 350 may determine software or firmware capability intent values associated with natural language descriptions of the gathered software or firmware capabilities. These software or firmware capability intent values are a mathematical representation of the natural language descriptions of capability operations or services from the one or more AI productivity tool-enableable software applications 311 or the AI productivity tool-enableable platform service tool 380 managing firmware capability actions to control one or more versions of firmware (e.g., 207, 291b, 293b, 295b of FIG. 2), or one or more hardware components (e.g., 208, 291a, 293a, 295a of FIG. 2) in an embodiment. These software or firmware capability intent values may be represented by a mathematical value in a multi-axis vector space that may be associated with the natural language description for that capability or intent. In an embodiment, the software or firmware capabilities may also be associated with an identification (ID) such as an alphanumeric ID that may be stored within a capability intent values database 356. Generating such software or firmware capability intent values as vectors may be a first step in a natural language processing method to determine software or firmware capability corresponding to and responsive to the user’s intent or requested action within a user query input that takes into account the context or semantics of the words used within the user query input.

In an embodiment, the capability intent values database 356 may store a plurality of software or firmware capability intent values of capabilities embedded via an embedding algorithm from the natural language descriptions of capabilities in the natural language capability database 355. The capability intent values database 356 may store include a name, capability ID, natural language descriptor, or a capability intent value for each available software or firmware capability in some embodiments. It is understood that in some embodiments, the natural language capability database 355 and the capability intent values database 356 may be the same database whereas in other it may be a distributed database. These software and firmware capabilities stored at the capability intent values database 356 may further include any input and output for the software or firmware capabilities executable by the hardware processor 302 or any other hardware processing devices, such as embedded controller 304.

The software or firmware capabilities may be registered with the OTB AI productivity tool 350 in an embodiment for establishing capability intent values for these software or firmware capabilities such that chat user query input embedded as query intent values may be correlated with one or more software or firmware capability intent values for registered software or firmware capabilities, as described herein. For example, an embedded controller executing machine readable code instructions for the AI productivity tool-enableable platform service tool 380 in embodiment may register with the OTB AI productivity tool 350 at the capability gathering module 353 an updated firmware capability or updated list of firmware capabilities that adds or removes a previously stored a natural language descriptions of firmware capabilities. The AI productivity tool-enableable platform service tool 380 may update registered firmware capabilities pursuant to the platform level capabilities gathering module 281 gathering notified functionality adjustments to firmware or hardware components as described above with respective to FIG. 2.

The software or firmware capability intent values for registered software or firmware capabilities are a vectorized mathematical representation in a multi-axis vector space of the natural language descriptions of capability operations or services from AI productivity tool-enableable software applications 311 or the one or more versions of firmware (e.g., 207, 291b, 293b, 295b of FIG. 2), or one or more hardware components (e.g., 208, 291a, 293a, 295a of FIG. 2) managed via the embedded controller executing the AI productivity tool-enableable platform service tool 380 in an embodiment. The software or firmware capability intent values are generated using natural language processing (NLP) techniques via execution of machine readable code instructions by the hardware processor 302 of the query intent determination module 351 and the text embedding module 365 in an example embodiment. Each axis of the multi-axis vector space may provide a measurement of various meaning value attributes of a text excerpt of words or phrases that are known to provide context or semantic understanding of the text. For example, one or more axis values may represent a reader’s understanding of a given text excerpt may depend upon the reader’s knowledge of any given word’s meaning within the text, identified phrases within the text, or the understood order or sequence of words within the text. More specifically, one or more axis values may represent the reader’s understanding as enhanced with a larger vocabulary and assigned values for which words in that vocabulary are synonyms (closer in meaning) to a given word in that text, and which words are antonyms (further away in meaning) to that given word. As another example, one or more axis values may represent the reader’s ability to identify common phrases, such as “in other words” may provide greater insight to the semantic meaning of a text excerpt using this phrase than an understanding of each of the words “in,” “other,” and “words” used separately from one another would. As yet another example, one or more axis values may represent the importance of the order of certain words in an excerpt may impact semantic meaning of the excerpt. More specifically, the phrase “man bites dog” may have a completely different semantic or contextual meaning than the phrase “dog bites man,” although each phrase has the same words, just in a different order.

Each axis of the multi-axis vector space, and thus, each value within a vector within such a multi-axis vector space may provide a measurement of these various attributes within a given initial or updated capability intent value in embodiments herein. Hundreds of vector axes may be the basis for the intent vector value in a multi-dimensional “space.” For example, a vector for a user query input intent value or for capability intent value may provide a measurement of similarity between any given word within the user query input or the capabilities, respectively, a measurement of dissimilarity with known antonyms, identification of any given word as part of a phrase, or usage of any given word in a specific order that is known to be of importance. In such a way, the vectorized user query input intent value and software or firmware capability intent values may mathematically represent a reader’s contextual or semantic understanding of the user query input and the natural language descriptors for the capabilities of the AI productivity tool-enableable platform service tool 380, one or more versions of firmware (e.g., 207, 291b, 293b, 295b of FIG. 2), or one or more hardware components (e.g., 208, 291a, 293a, 295a of FIG. 2). These vectors may then be compared to one another, via the hardware processor 302 executing machine readable code instructions of the semantic similarity search module 366 to determine statistical correlation, in order to understand how alike various phrases within the user query input and the software or firmware capabilities are, and how alike the usage of those words and phrases are to provide a context, such as influenced by the order of those words or phrases and their relation to one another, as well as other semantic factors represented in the multi-axis vector space.

The hardware processor 302 may also execute machine readable code instructions of a text embedding module 365 to detect which of these words are nouns, verbs, or commonly used sentence structures and generate a vectorized query input intent value for the user query input. These vectorized capability intent values and vectorized query input intent values may then be compared to one another, via the hardware processor 302 executing machine readable code instructions of the semantic similarity search module 366, in order to determine a statistical correlation that represents understanding how alike various phrases within the user query input and software or firmware capabilities are, and how alike the usage of those words and phrases are to provide a context, such as influenced by the order of those words or phrases and their relation to one another. For example, the hardware processor 302 executing machine readable code instructions of the semantic similarity search module 366, and in some embodiments in tandem with algorithms of the text embedding module 365 may compare the vectorized query input intent value with the software or firmware capability intent values stored within the capability intent value database 354 to identify a software or firmware capability intent value correlated to the query input intent value. This similarity matching correlation indicates that the user query input is requesting that the AI productivity tool-enableable software application for a software capability execute or the AI productivity tool-enableable platform service tool 380 coordinate controls of one or more versions of firmware (e.g., 207, 291b, 293b, 295b of FIG. 2), for one or more hardware components (e.g., 208, 291a, 293a, 295a of FIG. 2) execute the a firmware capability associated with that software or firmware capability intent value. Such a comparison, in an embodiment, may include, for example, determining a distance or a vector value difference between the vectorized query input intent value and the vectorized software or firmware capability intent value or a correlation value between the two. Examples of semantic similarity search module 366 algorithms may include, for example, a Cosine Similarity search machine learning model, a vector space model (VSM) similarity search machine learning model, or a K-Means Text Clustering similarity search machine learning model. These are only a few examples of semantic similarity search algorithms that may be employed and it is contemplated that any known or later-developed semantic similarity search algorithm may also be employed.

Upon determination of firmware capability intent value for each of the updated firmware capabilities gathered by the platform level capabilities module 381 and transmitted to the capabilities gathering module 353 of the OTB AI productivity tool 350 by the AI productivity tool-enableable platform service tool 380, OTB AI productivity tool 350 may begin processing received user query inputs. The user query inputs are received at the universal conversational interface software application 370 or other interface for identification and execution of responsive software or firmware capabilities corresponding to one or more of these software or firmware capability intent values.

In an example embodiment, a user may provide a user query input in the form of text or voice data (e.g., via IO device 190, or microphone 191a of FIG. 1) to a universal user conversational interface software application 370, executing machine readable code instructions as a chatbot with the OTB AI productivity tool 350 to simulate a conversation between the user and OTB AI productivity tool 350. When a user provides a user query input in the form of text or voice data (e.g., via IO device 190, or microphone 191a of FIG. 1) to the universal user conversational interface software application 370, the hardware processor 302 executing machine-readable code instructions of the OTB AI productivity tool 350 in an embodiment may orchestrate assessment of the user’s intended goals within the user query input (e.g., what the user wishes to achieve with this communication) with determination of a query input intent value. This user query input value is then used identify one or more software or firmware capabilities associated with the AI productivity tool-enableable software applications 311 or one or more versions of firmware (e.g., 207, 291b, 293b, 295b of FIG. 2) for one or more hardware components (e.g., 208, 291a, 293a, 295a of FIG. 2) managed by the AI productivity tool-enableable platform service tool 380 that have a correlating software or firmware capability intent value and that is capable of executing a response to this user query input intent. Further, the OTB AI productivity tool 350 may initiate performance of one or more tasks employing those software or firmware capabilities to achieve the user-intended results to the user query input.

This orchestration in an embodiment may begin with the hardware processor 302 executing machine-readable code instructions of the query intent determination module 351 to receive the user query input via microphone, image, or text input, and initiate execution of machine readable code instructions for an intent recognition pipeline machine learning module 361. In an embodiment, the hardware processor 302 executing machine-readable code instructions for the intent recognition pipeline machine learning module 361 may further orchestrate any combination of a plurality of machine learning modules (e.g., 363, 365, or 366) to process the audio, image, or text input to determine the user’s intended goal or query intent within the received text or voice data of the user query input.

During operation for example, the hardware processor 302 executing machine-readable code instructions of the query intent determination module 351 may load one or more machine learning models such that, for example, the text or voice input from the user may be processed through a speech recognition model 363 and/or processed through any of a plurality of natural language models (e.g., 365 or 366) or other ML models in order to determine a text of a user’s input query or a vectorized query intent value in multi-axis space of the user’s input query. For example, an automatic speech recognition (ASR) module 363, a text embedding module 365, or a semantic similarity search module 366 that work in various combinations with one another to detect a user’s audio speech input, conversion to text or detecting text, and detecting an intent, represented by generating a query intent vector value from the text of the user query input received from the universal user conversational interface software application 370 or other interface.

Further, the hardware processor 302 executing machine-readable code instructions of an intent recognition pipeline machine learning module 361 may orchestrate the interplay between each of the ASR module 363 and text embedding module 365to establish a query intent vector value in a multi-axis vector space defined with these machine learning models, as well as a semantic similarity search module 366 to correlate that query intent value with a corresponding capability intent value in an embodiment. Several text embedding algorithms may be used in various embodiments herein in order to provide a vectorized mathematical representation of semantic understanding for a user query input or for a capability described in natural language. For example, the text embedding module 365 may employ a Latent Semantic Analysis (LSA) or Latent Dirichlet allocation (LDA) which may define how close each of the observed terms in the received user query input are to various synonyms. As another example, the text embedding module 365 may employ a Word2Vec algorithm, which includes a neural network trained to understand which terms or phrases should be considered closer or further away from certain synonyms or antonyms. As yet another example, the text embedding module 365 may employ a fully recurrent neural network trained to consider the order of terms within the received user query input. Similar text embedding algorithms may be applied to embed the natural language descriptors of the software or firmware capabilities in embodiments herein.

In an embodiment in which the user provides text data to the OTB AI productivity tool 350, the intent recognition pipeline machine learning module 361 may truncate this process to exclude processes of the ASR module 363 in example embodiments. The hardware processor 302 executing machine-readable code instructions of the intent recognition pipeline machine learning module 361 in an embodiment may apply the text embedding module 365 to generate a query intent value as described and then return the output query intent value of the text embedding module 365 to the query intent to capability determination module 352. The query intent to capability determination module 352 may utilize the semantic similarity search module 366 for a correlation between the query intent value received and a stored software or firmware capability intent value for available software or firmware capabilities.

In embodiments herein, a hardware processor 302 may execute machine readable code instructions for a semantic similarity search module 366, via a query intent to capability determination module 352, that compares the vectorized user query input intent value and the registered software or firmware capability intent values stored within the capability intent values database 356. Such a comparison may be performed using a semantic search machine learning model, such as a cosine or other semantic similarity search algorithm that compares the distance or value difference in a multi-axis vector space between two vectors to determine the contextual similarity between the embedded text of natural language description of the software or firmware capabilities having the generated software or firmware capability intent values and the natural language user query input having an user query input intent value generated from an embedded text algorithm. Such a contextual or semantic search methodology may take into account the fact that the same word may have two meanings or consider synonyms of words, for example based on generated intent values of multiple words or recognized phrases or parts of speech that yield the vector intent value from the text embedding algorithm machine learning models used to generate capability and query intent vector values. The cosine similarity search comparison or other semantic similarity search algorithm may be performed for several of the software or firmware capability intent values stored within the capability intent value database 356 to identify a best match software or firmware capability intent value that most closely matches the user query input value, according to embodiments herein.

A hardware processor 302 executing machine readable code instructions for a semantic similarity search module 366 may determine a distance, that is a value difference of the vector intent values within the multi-axis vector space between the query input intent value and each of a plurality of software or firmware capability intent values. Then, for each of those determined distances, the hardware processor 302 executing machine readable code instructions for a semantic similarity search module 366 may determine an angular similarity having a value between zero and one for the query input intent value and each of a plurality of software or firmware capability intent values. This angular similarity value in an embodiment may comprise the semantic similarity search score for a given software or firmware capability intent value, where zero is a worst match and one is a best match between the given software or firmware capability intent value and the query input intent value.

The hardware processor 302 in an embodiment may execute machine readable code instructions of an OTB AI productivity tool 350 query intent to capability determination module 352 to identify the natural language capability having a highest semantic similarity search score that meets a minimum threshold value (e.g., 0.5, 0.7, 0.9) as the best match software or firmware capability for the received user query input. In other embodiments, hardware processor 302 in an embodiment may execute machine readable code instructions of an OTB AI productivity tool 350 query intent to capability determination module 352 to identify the natural language capabilities having semantic similarity search scores that meet a threshold value (e.g., 0.7 or 0.9) as one or more best match software or firmware capability for the received user query input. In the case where no natural language capability has a semantic similarity search score meeting the minimum threshold value, this may indicate that the software or firmware action requested by the user within the user query input cannot be performed by AI productivity tool-enableable software applications 3131 or the AI productivity tool-enableable platform service tool 380 managing one or more versions of firmware (e.g., 207, 291b, 293b, 295b of FIG. 2) for one or more hardware components (e.g., 208, 291a, 293a, 295a of FIG. 2). This may occur, for example, if the user is requesting execution or use of functionality not supported by the current or most updated capabilities from the AI productivity tool-enableable platform service tool 380 for one or more versions of firmware (e.g., 207, 291b, 293b, 295b of FIG. 2), or one or more hardware components (e.g., 208, 291a, 293a, 295a of FIG. 2). In such a scenario, the OTB AI productivity tool 350 may inform the user, via the universal user conversational interface software application 370 that the request action cannot currently be performed.

In other example embodiments, the OTB AI productivity tool 350 may identify one or more best match firmware capabilities one or more versions of firmware (e.g., 207, 291b, 293b, 295b of FIG. 2), or one or more hardware components (e.g., 208, 291a, 293a, 295a of FIG. 2) to be executed via the AI productivity tool-enableable platform service tool 380 at the platform level that meets the threshold similarity score value. For example, in an embodiment in which the user has provided a natural language user query input requesting adjustment of battery functionality, the hardware processor 302 executing machine readable code instructions for the OTB AI productivity tool 350 may identify a best match firmware capability for controlling minimizing battery usage or for optimizing battery charging that meets the threshold similarity value. As another example, in an embodiment in which the user has provided a natural language user query input requesting adjustment of the keyboard backlight level, the hardware processor 302 executing machine readable code instructions for the OTB AI productivity tool 350 may identify a best match firmware capability to control turning on or off a keyboard backlight or to optimize keyboard backlight for power consumption that meets the threshold similarity score value. In yet another example, in an embodiment in which the user has provided a natural language user query input requesting adjustment of system cooling methods or functionality, the hardware processor 302 executing machine readable code instructions for the OTB AI productivity tool 350 may identify a best match firmware capability control cooling the information handling system, to increase or decrease fan speed, or to optimize fan speed for power consumption that meets the threshold similarity score value.

Upon identification of an updated firmware capability that addresses the determined query “intent” of the user within the received user query input, the hardware processor 302 executing machine-readable code instructions of the OTB AI productivity tool 350 may direct execution of one or more processes at the AI productivity tool-enableable platform service tool 380 managing the one or more versions of firmware (e.g., 207, 291b, 293b, 295b of FIG. 2), or one or more hardware components (e.g., 208, 291a, 293a, 295a of FIG. 2) associated with that firmware capability at the platform level. In such a way, the OTB AI productivity tool 350 may implement a number of actions or utilizes services of the AI productivity tool-enableable platform service tool 380 for the one or more versions of firmware (e.g., 207, 291b, 293b, 295b of FIG. 2), or one or more hardware components (e.g., 208, 291a, 293a, 295a of FIG. 2) based on the natural language of a received user query input at the OS level to trigger platform level firmware capability actions that are currently supported by configurations, settings or policies for the one or more versions of firmware (e.g., 207, 291b, 293b, 295b of FIG. 2), or one or more hardware components (e.g., 208, 291a, 293a, 295a of FIG. 2), as also described above with respect to FIG. 2.

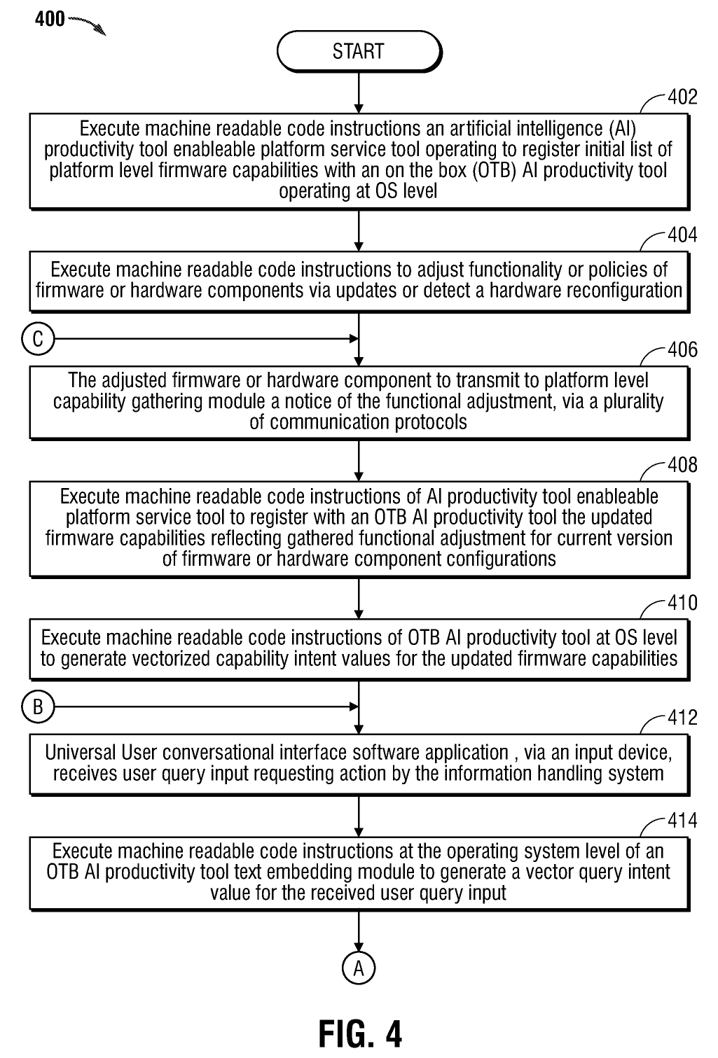

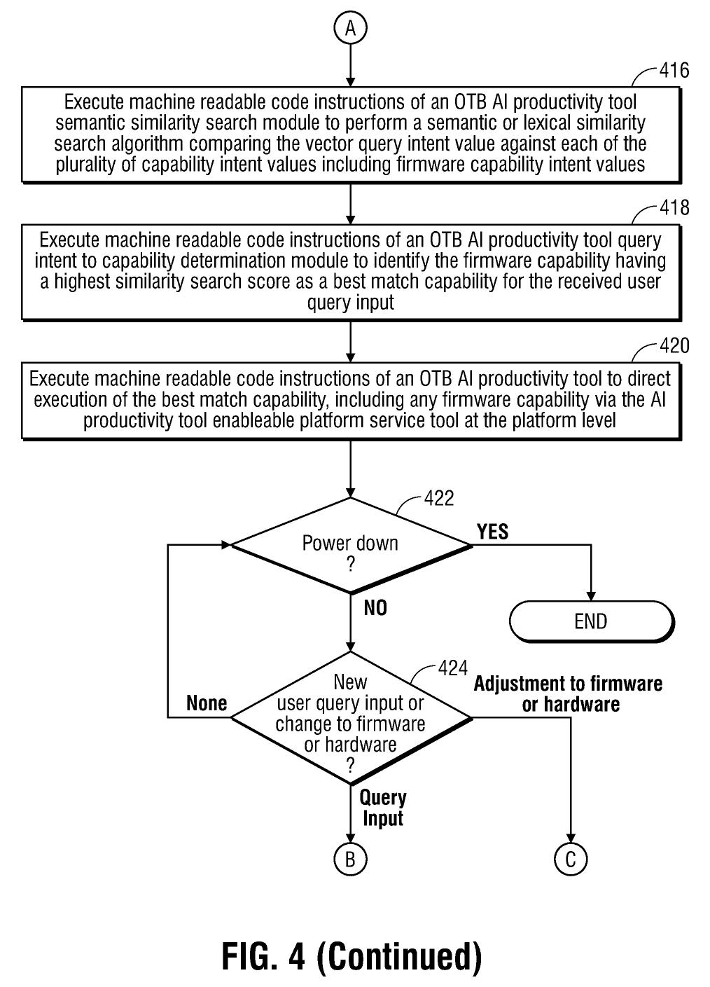

FIG. 4 is a flow diagram illustrating a method of a hardware processor or embedded controller executing machine readable code instructions to update a pre-registered runtime firmware capability for firmware or a hardware component that is in accordance with current versions, hardware configurations and policies at an on the box (OTB) artificial intelligence (AI) tool according to an embodiment of the present disclosure and executing the updated firmware capability pursuant to a user query input received. As described herein, execution of code instructions of a platform level capabilities gathering module in an embodiment may act as a hub to gather and consolidate notifications of changes to current versions, hardware configurations and policies for various firmware versions or hardware components to an AI productivity tool enableable platform service tool. Execution of the AI productivity tool-enableable platform service tool transmits to and registers updated firmware capabilities with the OTB AI productivity tool via a single communication protocol (ACPI). Execution of the OTB AI productivity tool may receive user query inputs for matching with capabilities including the updated registered firmware capabilities to determine a responsive capability to the user query input in embodiments herein.

At block 402, a hardware processor in an embodiment may execute machine readable code instructions of an artificial intelligence (AI) productivity tool enableable platform service tool operating at a platform level, below operating system (OS) level of information handling system, to register a default list of firmware capabilities with an on the box (OTB) AI productivity tool operating at OS level. The firmware capabilities registered with the OTB AI productivity tool may include natural language descriptions for registration and storage at a natural language capabilities database with software capabilities of one or more AI productivity tool enableable software applications executable at the OS level of the information handling system. These registered firmware capabilities may further be embedded as firmware capability intent values for storage in a capability intent values database with software capability intent values for registration of available responsive capabilities accessible by the OTB AI productivity tool.

For example, in an embodiment, the AI productivity tool-enableable platform service tool may register firmware capabilities of one or more versions of firmware for one or more hardware components with the OTB AI productivity tool that are firmware capabilities achievable by the AI productivity tool enableable platform service tool. In one example embodiment, a firmware capability may describe functionalities for a battery, such as firmware adjustments for various power mode settings such as a power saving mode for a PMU and the battery. In another example embodiment, a firmware capability registered at the OTB AI productivity tool may include functionalities of the keyboard with firmware capabilities capable to power on or off a keyboard backlight. In still another example embodiment, a firmware capability registered at the OTB AI productivity tool may include functionalities of the cooling device firmware to adjust settings for a cooling device according to a user selectable thermal table (USTT) that is updatable which may cause a firmware capability to adjust increasing or decreasing fan speed. The above are some examples of firmware capabilities for hardware components operating at the platform level of the information handling system that may be registered firmware capabilities and it is contemplated that any firmware or hardware components operating at the firmware level may be included as registered firmware capabilities with the OTB AI productivity tool by the AI productivity tool enableable platform service tool.

In an embodiment at block 404, the hardware processor, or an embedded controller may execute machine readable code instructions to adjust functionality or policies of firmware or hardware components, or hardware configuration or firmware policy settings may be adjusted such as by firmware updates or change in version in some embodiments. The firmware capabilities that are registered with the OTB AI productivity tool in an embodiment may be routinely updated or adjusted at a platform level by a user, an updated version, or by an information technology decision maker (ITDM) managing an enterprise of information handling systems. In some cases, the embedded controller executing machine readable code instructions for the AI productivity tool-enableable platform service tool itself may perform such a functionality adjustment that adds or removes functionality of various firmware or hardware components in embodiments.

At block 406, an embedded controller may execute machine readable code instructions of for firmware for an adjusted hardware component to transmit a notice of the functional adjustment to an embedded controller executing machine readable code instructions of a platform level capability gathering module. In embodiments herein, a plurality of communication protocols may be used to communicate the notice of the functional adjustment from a firmware version or from a hardware component to the embedded controller depending on the type of hardware component.

For example, upon updating or adjustment of the hardware component by a user, a version update, or by an ITDM, such as for a battery (e.g., removal of the battery), the firmware or policies for execution of the firmware for the battery or a PMU in an embodiment may be subject to a functional adjustment. For example, a firmware capability may be added or removed for adjusting a power mode by a PMU for the battery. Then, hardware component or its firmware executing on a controller for the hardware component, such as a PMU or battery automatically transmits a notification of the functionality adjustment to the embedded controller executing the platform level capabilities gathering module. The PMU may communicate one functional adjustment on a first communication protocol while the battery or battery controller may communicate a separate functional adjustment on a second communication protocol. In another example embodiment, upon updating or adjustment of the firmware for a keyboard or policies for execution of the same to add or remove an initial capability to adjust the level of a keyboard backlight, the keyboard or a keyboard controller executing keyboard firmware may automatically transmit a notification of functionality adjustment indicating this update or adjustment to the embedded controller executing the platform level capabilities gathering module in one of a plurality of communication protocols.

In yet another example embodiment, upon updating or adjustment of the firmware for a cooling device, or policies for execution of the same to add or remove an initial capability for adjusting settings for the cooling device, such as for increasing or decreasing fan speed, under an updated USTT, the firmware or controller for the cooling device may automatically transmit a notification of functionality adjustment indicating this update or adjustment to the embedded controller executing the platform level capabilities gathering module in one of a plurality of communication protocols.

The embedded controller, in an embodiment, executing machine readable code instructions at a platform level for a platform level capability gathering module may receive these automated notifications for functional adjustments from each of the one or more versions of firmware or one or more hardware components as those changes occur through several different available communication protocols. For example, in an embodiment a single embedded controller executing machine readable code instructions for the platform level capability gathering module may allow for communication with some hardware components or among plural embedded controllers or microcontrollers using a universal asynchronous receiver/transmitter (UART) communication protocol. As another example embodiment, the embedded controller executing machine readable code instructions for the platform level capability gathering module in an embodiment may communicate with one or more controllers executing firmware or hardware components using an inter-integrated circuit (I2C), a universal asynchronous receiver/transmitter (UART) communication protocol, or a universal serial bus (USB) communication protocol or other. In yet another example, the embedded controller executing machine readable code instructions for the platform level capability gathering module in an embodiment may communicate with one or more versions of firmware executing on microcontrollers via a plurality of links using an I2C, UART, USB or other communication protocol. In still another example, embedded controller executing machine readable code instructions for the platform level capability gathering module in an embodiment may communicate with one or more hardware components via a plurality of links using the system management bus (SMBus) communication protocol, the UART communication protocol, the USB communication protocol, or in compliance with an input output control system (IOCTL) protocol, or other example communication protocols. In this way, the

The embedded controller in an embodiment at block 408 may execute machine readable code instructions of the AI productivity tool-enableable platform service tool at the platform level to register with the OTB AI productivity tool an updated list of firmware capabilities reflecting current configurations, policies, or functionalities for the AI productivity tool-enableable platform service tool of the firmware for one or more hardware components. This updated list of firmware capabilities for registration is based on the gathered notices of functional adjustment to current versions of firmware and hardware component configurations and policies given within the notices of functional adjustment at the platform level capabilities gathering module.

For example, firmware for a PMU or battery that is generally capable of optimizing battery performance as managed by an AI productivity tool-enableable platform service tool may have an initial list of firmware capabilities registered at block 402 above having natural language processing (NLP) defined firmware capabilities that include operations at the PMU or battery to minimize battery usage or optimize battery charging. Updating or an adjustment of firmware for or configuration of a hardware component such as the PMU or battery (e.g., removal of the battery) an updated firmware version or other functional adjustment may remove or make obsolete the initial firmware capabilities to minimize battery usage or optimize battery charging at the PMU or battery. The AI productivity tool-enableable platform service tool will automatically transmit and register changes to firmware capabilities, such as from functionality adjustments gathered by the platform level capabilities gathering module, at the OTB AI productivity tool at the OS level. This may include the AI productivity tool-enableable platform service tool to register new firmware capabilities or remove previously registered firmware capabilities from a natural language capabilities database and capability intent values database accessible by the OTB AI productivity tool. For example, the embedded controller 204 executing machine readable code instructions for the AI productivity tool-enableable platform service tool in the example embodiment may then transmit an updated capability or updated list of capabilities that removes a natural language description for the firmware capabilities for the PMU or battery to conduct actions to minimize battery usage or to optimize battery charging.

As another example, keyboard firmware or a keyboard that is generally capable of modulating power to a keyboard backlight may have an initial list of firmware capabilities registered at block 402 and having embedded firmware capability intent values that may control turning off or on keyboard backlight, or conducting operations to optimize keyboard backlight for power consumption. Such firmware capabilities may be controlled from an OTB AI productivity tool at the OS level via an interface with the AI productivity tool-enableable platform service tool executing on the embedded controller to manage such responsive firmware capability actions at the platform level. Upon updating or adjustment of the keyboard, keyboard firmware, or policies for execution of the same by a user, a version update, or by an ITDM to adjust, add, or remove one or more of these initial firmware capabilities, the AI productivity tool-enableable platform service tool will automatically transmit and register changes to firmware capabilities, such as from functionality adjustments gathered by the platform level capabilities gathering module, at the OTB AI productivity tool at the OS level. The embedded controller executing machine readable code instructions for the AI productivity tool-enableable platform service tool in such an example embodiment may then transmit an updated firmware capability or updated list of firmware capabilities that adds, modifies or omits a natural language description for the registered firmware capabilities. For example, added or modified firmware capabilities may include adjusting brightness levels of keyboard backlight between on and off or adding additional control actions for optimizing keyboard backlight operation for power consumption.

In another example, firmware or a cooling device that is generally capable of adjusting settings for the cooling device, such as a fan speed, according to a USTT may have an initial list of firmware capabilities registered at block 402 for controlling an increase or decrease of fan speed based on current USTT or firmware controls for fan speed based on power consumption needs. Upon updating or adjustment of the firmware or the cooling device or policies for execution of the same, one or more initial firmware capabilities may be added, adjusted, or removed. The embedded controller 204 executing machine readable code instructions for the AI productivity tool-enableable platform service tool may automatically transmit an updated capability or updated list of capabilities to the OTB AI productivity tool.

These updated firmware capabilities for the one or more versions of firmware or one or more hardware components may then be transmitted by the AI productivity tool-enableable platform service tool to the OTB AI productivity tool operating at the OS level via a single type of communication link using a single communication protocol. For example, the embedded controller executing the AI productivity tool-enableable platform service tool may transmit the updated firmware capability or list of updated firmware capabilities to the hardware processor executing the OTB AI productivity tool at the OS level with an Advanced Configuration and Power Interface (ACPI) communication protocol link. The platform level capabilities gathering module acting as a hub to gather and consolidate functional adjustments to a variety of firmware or hardware components at the platform level and provide to the AI productivity tool enableable platform service tool. The AI productivity tool enableable platform service tool transmits to the OTB AI productivity tool the routine or real-time updates reflecting current configurations, policies, or functionalities for the AI productivity tool-enableable platform service tool of the firmware for one or more hardware components via this single communication protocol (e.g., ACPI). This may be the same communication protocol link used by the OTB AI productivity tool at the OS level to transmit selected responsive firmware capabilities to the AI productivity tool-enableable platform service tool to coordinate execution in firmware at the platform level. These updates to the firmware capabilities will then reflect current configurations, policies, or functionalities for the AI productivity tool-enableable platform service tool of the firmware for one or more hardware components and are then registered with the OTB AI productivity tool and stored at the natural language capabilities database. This alleviates the need for the hardware processor executing code instructions at the OS level for the OTB AI productivity tool to communicate with both the AI productivity tool-enableable platform service tool for execution of responsive firmware capabilities separately and in addition to one or more versions of firmware or one or more hardware components via the plurality of various communication protocols linking these devices or controllers to the OS level hardware processor. This may, in turn, increase efficiency and speed of the OTB AI productivity tool itself.

At block 410, in an embodiment, the hardware processor may execute machine readable code instructions of OTB AI productivity tool at the OS level to generate vectorized capability intent values for the natural language descriptions of firmware capabilities in the updated or initial list of firmware capabilities received from the AI productivity tool-enableable platform service tool. For example, in an embodiment, each of the software or firmware capabilities stored at the capability intent values database, including any firmware capabilities that are updated by the AI productivity tool-enableable platform service tool, may have a description with text descriptors, may be associated with a unique ID, and may have a capability intent value generated based on those text descriptors in an embodiment. Upon registration or updating of a given firmware capability by the AI productivity tool-enableable platform service tool in an embodiment, a hardware processor for the information handling system may execute machine readable code instructions of a natural language capability intent module utilizing one or more text embedding algorithms of a text embedding module to generate a multi-axis vector capability intent value for that capability, including updated firmware capabilities, that is based on text descriptors for that capability. Each axis of the multi-axis vector space may provide a measurement of various attributes of a text excerpt that are known to provide context or semantic understanding of the text. Further, each of these updated firmware capability intent values generated by the text embedding module for association with these initial or recently updated firmware capabilities may also be associated with a capability identification value or capability ID such as an alphanumeric ID that may identify, uniquely, each of these firmware capabilities in the capability intent values database, for example.

Each axis of the multi-axis vector space, and thus, each value within a vector within such a multi-axis vector space may provide a measurement of these various attributes within a given initial or updated capability intent value in embodiments herein. For example, a vector for a user query input intent value or for capability intent value may provide a measurement of similarity between any given word within the user query input or registered capabilities, respectively. In other embodiments, some other axis values may provide a measurement of dissimilarity with known antonyms, identification of any given word as part of a phrase, or usage of any given word in a specific order that is known to be of importance. In such a way, the vectorized user query input intent value and capability intent values may mathematically represent a reader’s contextual or semantic understanding of the capability natural language text descriptors as well as for a user query input to allow for semantic as well as lexical comparison in some embodiments as described below.

The hardware processor at block 412 in an embodiment executing machine readable code instructions for the universal user conversational interface software application may receive, via an input device, a user query input requesting action by the information handling system. For example, in embodiments described herein, a user may provide text or voice data (e.g., via any IO device such as a microphone) to a universal user conversational interface software application operating as a chatbot to simulate a conversation between the user and the OTB AI productivity tool.

At block 414 in an embodiment, the hardware processor may execute machine readable code instructions at the operating system level of an OTB AI productivity tool text embedding module to generate a vector query intent value for the received user query input. For example, in an embodiment, a hardware processor may execute machine-readable code instructions of the query intent determination module for the OTB AI productivity tool to receive the user query input via microphone, image, or text input, and initiate execution of machine readable code instructions for an intent recognition pipeline machine learning module.

The hardware processor in an embodiment at block 416 may execute machine readable code instructions of an OTB AI productivity tool semantic similarity search module to perform a semantic or lexical similarity search algorithm comparing the vector query intent value against each of the plurality of capability intent values, including firmware capability intent values associated with firmware or hardware components and managed through execution of AI productivity tool-enableable platform service tool. For example, a hardware processor may execute machine readable code instructions for a semantic similarity search module, via a query intent to capability determination module, that compares the vectorized user query input intent value and the capability intent values stored within the capability intent values database. This may include updated firmware capability intent values as described above. Such a comparison may be performed using a semantic search machine learning model, such as a cosine or other semantic similarity search algorithm, that compares the distance or value difference or angular differences in a multi-axis vector space between two vectors to determine the contextual similarity between the software or firmware capability intent values and the user query input intent value generated from an embedded user query. Such a contextual or semantic search methodology may take into account the fact that the same word may have two meanings or consider synonyms of words, for example based on generated intent values of multiple words or recognized phrases or parts of speech that yield the vector intent value from the text embedding algorithm machine learning models used to generate capability intent values and query intent vector value. The cosine similarity search comparison or other semantic similarity search algorithm may be performed for several of the capability intent values stored within the capability intent value database to identify a best match that is a highest or threshold-level cosine semantic search score for either initial or updated capability intent value that sufficiently or most closely matches the user query input value, according to embodiments herein.

At block 418 in an embodiment, the hardware processor may execute machine readable code instructions of an OTB AI productivity tool query intent to capability determination module to identify the one or more firmware capability for a hardware component, or the AI productivity tool-enableable software capability having a highest similarity search score or a similarity search score meeting a threshold similarity search score level as the best match capability for the received user query input. For example, the hardware processor in an embodiment may execute machine readable code instructions of an OTB AI productivity tool query intent to capability determination module to identify the available firmware or software capability having a highest semantic similarity search score that meets a minimum threshold value (e.g., 0.5, 0.7, 0.9) as the best match capability for the received user query input in an embodiment. More specifically, in an embodiment in which the user has provided a natural language user query input requesting adjustment of battery functionality, the hardware processor executing machine readable code instructions for the OTB AI productivity tool may identify a best match capability as one or more updated firmware capabilities meeting a threshold semantic similarity value to adjust PMU or battery operation at the platform level to minimize battery usage, or to optimize battery charging. These updated firmware capabilities will reflect the current version of firmware or hardware configuration at the platform level in embodiments herein.

As another example, in an embodiment in which the user has provided a natural language user query input requesting adjustment of the keyboard backlight level, the hardware processor executing machine readable code instructions for the OTB AI productivity tool may identify best match capability as one or more updated firmware capabilities meeting a threshold semantic similarity value to execute firmware controls to adjust keyboard backlight levels between on and off, or to optimize keyboard backlight levels for power consumption. In yet another example, in an embodiment in which the user has provided a natural language user query input requesting adjustment of system cooling methods or functionality, the hardware processor executing machine readable code instructions for the OTB AI productivity tool may identify best match capability as one or more updated firmware capabilities meeting a threshold semantic similarity value to execute firmware controls increase or decrease fan speed of a fan or to control fan speed optimized for power consumption.

At block 420, in an embodiment in which a best match capability meeting a threshold semantic similarity value has been identified, the hardware processor may execute machine readable code instructions of an OTB AI productivity tool to direct execution of one or more processes that are associated with a best match firmware capability at firmware for hardware devices at the platform level via the single communication link with the embedded controller executing the AI productivity tool-enableable platform service tool. For example, in embodiments, upon identification of a responsive firmware capability that addresses the determined user query input, the hardware processor executing machine-readable code instructions of the OTB AI productivity tool may direct execution of one or more firmware processes via the AI productivity tool-enableable platform service tool to direct one or more versions of firmware to execute adjustment or operation of associated one or more hardware components. In such a way, the OTB AI productivity tool may implement a number of actions or utilizes services via the AI productivity tool-enableable platform service tool at the platform level to execute responsive firmware capabilities of one or more versions of firmware for control of one or more hardware components to respond to a received user query input. This execution of a responsive, updated firmware capability or capabilities in embodiments herein will be in accordance with currently supported by configurations, settings or policies for the one or more versions of firmware, or one or more hardware components.

Proceeding to block 422, the hardware processor may determine if the information handling system has been powered down. If so, the method for updating a pre-registered firmware capabilities for firmware or a hardware component at a platform level that is in accordance with current versions, hardware configurations and policies and for executing the updated firmware capabilities pursuant to a user query input may then end. If the information handling system has not been powered down, the method may proceed to block 424.

At block 424, the hardware processor executing the universal user conversational interface software application of the OTB AI productivity tool monitors to determine if another user query input has been received. Additionally, the embedded controller executing machine readable code instructions of the platform level capability gathering module and the AI productivity tool enableable platform service tool monitors for detection of another adjustment to functionality or policies for firmware or hardware component configuration at the platform level by a user, from version updates, or by an ITDM. If at block 424, another user query input has been received, the method returns to block 412 and proceeds from there. If at block 424, an adjustment to firmware or hardware has occurred and notice reported to the platform level capability gathering module, the method returns to block 406 and proceeds. If at block 424, neither is detected, the method returns to block 422 to determine if the information handling system will power down.

The blocks of the flow diagram of FIG. 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system operating an on the box (OTB) artificial intelligence (AI) productivity tool comprising:
an embedded controller executing machine readable code instructions of a platform level capability gathering module at a platform level of the information handling system to receive, via one of a plurality of communication protocols between the embedded controller and a plurality of hardware components, a published notice of functional adjustment for a hardware component within the plurality of hardware components;
the embedded controller executing machine readable code instructions of AI productivity tool enableable platform service tool to transmit an updated firmware capability for the hardware component for registration with the OTB AI productivity tool executing at the operating system (OS) level pursuant to the notice of functional adjustment;
a hardware processor executing machine readable code instructions the OTB AI productivity tool to generate a vectorized firmware capability intent value from the updated firmware capability and a vectorized query input intent value for a user query input received via a universal user conversational interface software application requesting a capability intent action on behalf of the information handling system;
the hardware processor executing machine readable code instructions of the OTB AI productivity tool to determine that the vectorized query input intent value for the user query input semantically correlates to the vectorized firmware capability intent value determined for the updated firmware capability, where semantic correlation indicates that the user query input requests performance of the updated firmware capability; and
the hardware processor executing machine readable code instructions for the OTB AI productivity tool to instruct AI productivity tool enableable platform service tool executing at the platform level, via the embedded controller, to perform the updated firmware capability at the hardware component.

2. The information handling system of claim 1, wherein embedded controller executing machine readable code instructions of AI productivity tool enableable platform service tool to transmit a list of updated firmware capabilities that removes a previous firmware capability and a previous feature that has been removed or disabled in a most recent update to firmware for the hardware component.

3. The information handling system of claim 1, wherein the updated firmware capability includes a new functionality that has been added pursuant to the functional adjustment notice of a most recent update to firmware for the hardware component.

4. The information handling system of claim 1, wherein the updated firmware capability includes a new functionality for the hardware component that has been added pursuant to the functional adjustment notice of a configuration change to the hardware component.

5. The information handling system of claim 1, wherein embedded controller executing machine readable code instructions of AI productivity tool enableable platform service tool to transmit a list of updated firmware capabilities that removes a previous firmware capability of a previous functionality for the hardware component that has been removed or disabled by a configuration adjustment to the hardware component.

6. The information handling system of claim 1 further comprising:
a hardware component controller executing machine readable code instructions to perform the functionality adjustment of firmware for the hardware component to trigger publication of the notification of the functional adjustment to the embedded controller executing the platform level capability gathering module.

7. The information handling system of claim 1 further comprising:
the embedded controller executing machine readable code instructions of the platform level capability gathering module to automatically publish the notice of functional adjustment for the hardware component to the AI productivity tool enableable platform service tool to determine addition, removal, or modification of registered firmware capabilities with the OTB AI productivity tool at the OS level.

8. A method for dynamically updating firmware capabilities at an on the box (OTB) artificial intelligence (AI) productivity tool of an information handing system comprising:
performing, via an embedded controller executing machine readable code instructions, a functionality adjustment for firmware for a hardware component or for a configuration change to the hardware component executing at a platform level for the information handling system;
automatically receiving, via the embedded controller executing machine readable code instructions of a platform level capability gathering module, a published notice of the functionality adjustment for the firmware or for the configuration change to the hardware component via a first communication protocol of a plurality of communication protocols connecting the embedded controller to hardware component microcontrollers executing hardware component firmware of plural hardware components;
transmitting in a second communication protocol, via the embedded controller executing machine readable code instructions of an AI productivity tool enableable platform service tool, an updated and consolidated list of firmware capabilities to the OTB AI productivity tool executing at an operating system (OS) level pursuant to the notice of the functionality adjustment;
generating, via a hardware processor executing machine readable code instructions of the OTB AI productivity tool, a vectorized firmware capability intent value for each of the updated firmware capabilities in updated and consolidated list of firmware capabilities and generating a vectorized query input intent value for a user query input received at the OTB AI productivity tool; and
instructing, via the hardware processor executing machine readable code instructions for the OTB AI productivity tool, the AI productivity tool enableable platform service tool at the platform level to execute a responsive updated firmware capability at firmware for the hardware component having a vectorized firmware capability intent value semantically correlated to the vectorized query input intent value indicating that the user query input requests performance of the updated firmware capability.

9. The method of claim 8 wherein the second communication protocol is a link adhering to the Advanced Configuration and Power Interface (ACPI) protocol between the hardware processor and the embedded controller.

10. The method of claim 8 further comprising:
receiving a plurality of functionality adjustments from a plurality of hardware components to the embedded controller executing the platform level capability gathering module via a first communication protocol and other communication protocols that are different from the second communication protocol.

11. The method of claim 8 further comprising:
receiving a plurality of functionality adjustments from hardware microcontrollers at the plurality of hardware components to the embedded controller executing the platform level capability gathering module via at least a first communication protocol selected from a system management bus (SMBus) communication protocol, an inter-integrated circuit (I2C) communication protocol, or a universal asynchronous receiver/transmitter (UART) communication protocol.

12. The method of claim 8 further comprising:
receiving a plurality of functionality adjustments from hardware microcontrollers at the plurality of hardware components to the embedded controller executing the platform level capability gathering module via at least a first communication protocol selected from a universal serial bus (USB) communication protocol, an input output control system (IOCTL) communication protocol or a universal asynchronous receiver/transmitter (UART).

13. The method of claim 8 further comprising:
transmitting the updated and consolidated list of firmware capabilities to the OTB AI productivity tool executing at the OS level pursuant to the notice of the functionality adjustment for the firmware or for the configuration change to the hardware component to remove a previously registered firmware capability with the OTB AI productivity tool when the functionality adjustment removes or disables a firmware capability action by a firmware or configuration adjustment to the hardware component.

14. The method of claim 8 further comprising:
transmitting the updated and consolidated list of firmware capabilities to the OTB AI productivity tool executing at the OS level pursuant to the notice of the functionality adjustment for the firmware or for the configuration change to the hardware component to modify a previously registered firmware capability with the OTB AI productivity tool when the functionality adjustment alters a firmware capability action by a firmware or configuration adjustment to the hardware component.

15. An information handling system operating an on the box (OTB) artificial intelligence (AI) productivity tool comprising:
an embedded controller executing machine readable code instructions of a platform level capability gathering module at a platform level of the information handling system to receive, via a plurality of communication protocols between the embedded controller and a plurality of hardware components, published notices of functional adjustments for firmware for hardware components or configuration changes to hardware components;
the embedded controller executing machine readable code instructions of AI productivity tool enableable platform service tool to transmit a list of updated firmware capabilities for registration with the OTB AI productivity tool executing at an operating system (OS) level at a capability database pursuant to the notices of the functionality adjustments for firmware or the hardware components;
a hardware processor executing machine readable code instructions the OTB AI productivity tool to generate vectorized firmware capability intent values for the list of updated firmware capabilities and a vectorized query input intent value for a user query input received at the OTB AI productivity tool;
the hardware processor executing machine readable code instructions of the OTB AI productivity tool to determine that the vectorized query input intent value for the user query input semantically correlates to a vectorized firmware capability intent value determined for a first updated firmware capability, where semantic correlation indicates that the user query input requests performance of the first updated firmware capability; and
the hardware processor executing machine readable code instructions for the OTB AI productivity tool to instruct the AI productivity tool enableable platform service tool executing at the platform level to perform the first updated firmware capability at a hardware component.

16. The information handling system of claim 15 further comprising:
a hardware component controller executing machine readable code instructions to perform the functionality adjustment to firmware for a first hardware component of the plurality of hardware components to trigger publication of the notification of the functional adjustment to the embedded controller executing the platform level capability gathering module.

17. The information handling system of claim 15, wherein the list of updated firmware capabilities removes a previous firmware capability and a previous feature that has been removed or disabled in a most recent update to firmware for a first hardware component of the plurality of hardware components.

18. The information handling system of claim 15, wherein the list of updated firmware capabilities includes a new functionality that has been added pursuant to the functional adjustment notice of a most recent update to firmware for a first hardware component of the plurality of hardware components.

19. The information handling system of claim 15 further comprising:
the embedded controller executing machine readable code instructions of the AI productivity tool enableable platform service tool to determine addition, removal, or modification of registered firmware capabilities with the OTB AI productivity tool at the OS level from the published notices of functional adjustments from the platform level capability gathering module.

20. The information handling system of claim 15 further comprising:
the hardware processor executing the OTB AI productivity tool operatively coupled to the embedded controller executing the AI productivity tool enableable platform service tool via a first communication protocol; and
the embedded controller operatively coupled to hardware component controllers executing firmware for the plurality of hardware components via the plurality of communication protocols between the embedded controller and the plurality of hardware components that are different from the first communication protocol.
